(19) United States
(12) Patent Application Publication
(10) Pub. No.: US 2026/0020610 A1
(43) Pub. Date: Jan. 22, 2026

(54) HEATER ASSEMBLY WITH A VARIABLE CROSS-SECTION HEATING ELEMENT FOR AN AEROSOL-GENERATING DEVICE

(71) Applicant: Philip Morris Products S.A., Neuchatel (CH)

(72) Inventor: Enrico TURRINI, Neuchâtel (CH)

(73) Assignee: Philip Morris Products S.A., Neuchatel (CH)

(21) Appl. No.: 18/994,676

(22) PCT Filed: Jul. 28, 2023
(86) PCT No.: PCT/EP2023/071013

§ 371 Date: Jan. 15, 2025

(30) Foreign Application Priority Data
Aug. 5, 2022 (EP) 22189068.4

(51) Int. Cl. A24F 40/46; A24F 40/10; A24F 40/42; A24F 40/44; A24F 40/57; H05B 3/26

(52) U.S. Cl. CPC A24F 40/46; A24F 40/10; A24F 40/42; A24F 40/44; A24F 40/57; H05B 3/26; H05B 2203/016

(57) ABSTRACT

A heater assembly for an aerosol-generating device is provided, including: a heating element; first and second electrical contacts in electrical contact, respectively, with first and second ends of the element, the element providing a continuous electrical path between the first and the second contacts; and a frame including an aperture in a first plane, the element including heating portions and an attachment portion therebetween along the path, the element fixed to the frame and each heating portion within or overlying the aperture and separated from the frame by the attachment portion, a cross-sectional area of each heating portion perpendicular to a direction of the path being less than that of each attachment portion perpendicular to the direction, the element including a heat-isolating portion, each attachment portion separated from the frame by one heat-isolating portion, and the heating portions, the attachment portion, and the heat-isolating portion are all integrally formed.

The present disclosure relates to a heater assembly for an aerosol-generating device or a cartridge; an aerosol-generating device comprising a heater assembly; an aerosol-generating system comprising a cartridge and an aerosol-generating device; and a cartridge comprising a heater assembly.

Aerosol-generating systems configured to generate inhalable aerosol from an aerosol-forming substrate are known in the art. Some prior aerosol-generating systems comprise an aerosol-generating-device that is couplable to a cartridge. A typical cartridge for use with an aerosol-generating device comprises an aerosol-forming substrate and a heater assembly, where the heater assembly comprises a heating element. Often, the aerosol-forming substrate is a liquid. In this case, the cartridge may further comprise a wicking material in fluidic communication with the aerosol-forming substrate and in contact with the heating element. The wicking material is configured to transport liquid aerosol-forming substrate to the heating element. In use, the heating element is configured to vaporise the liquid aerosol-forming substrate. For example, the heating element may be restively heated. An airflow is provided past the heating element to entrain the generated vapour. In the airflow the vapour is condensed and an aerosol is formed. The aerosol may then be inhaled by a user. The aerosol-generating device typically comprises a power supply that is configured to supply power to the heating element when the device and cartridge are coupled together, via electrical connectors.

In aerosol-generating systems of this type, the heating element is secured to other components of the heater assembly, aerosol-generating device, cartridge, or aerosol-generating system, depending on the location of the heating element. This provides stability to the heating element, and can minimise damage to the heating element during use. However, as the heating element is at an elevated temperature during use, heat may be transferred from the heating element to other components of the heater assembly, aerosol-generating device, cartridge, or aerosol-generating system. This heat transfer may damage these other components. Additionally, this heat transfer may cause other components of the aerosol-generating device, cartridge, or aerosol-generating system to become hot to the touch during use, which would be detrimental to the overall experience of the user.

It would therefore be desirable to provide a heater assembly, an aerosol-generating device, a cartridge, and an aerosol-generating system, which during use minimises heat transfer between the heating element and other components of the heater assembly, aerosol-generating device, cartridge, or aerosol-generating system.

According to a first embodiment of the present disclosure, there is provided a heater assembly for an aerosol-generating device. The heater assembly may comprise a heating element, a first electrical contact in electrical contact with a first end of the heating element, and a second electrical contact in electrical contact with a second end of the heating element. The heating element may provide a continuous electrical path between the first electrical contact and the second electrical contact. The heating element may comprise a plurality of heating portions. The heating element may further comprise at least one attachment portion. The at least one attachment portion may be positioned between heating portions along the continuous electrical path. The heating element may comprise a frame comprising an aperture in a first plane, wherein the heating element is fixed to the frame and. Each heating portion may be within or overlie the aperture. Each heating portion may be separated from the frame by at least one attachment portion. The cross sectional area of each heating portion perpendicular to the direction of the continuous electrical path may less than the cross sectional area of each attachment portion perpendicular to the direction of the continuous electrical path. Advantageously, heat transfer from the heating element to the frame is therefore reduced. Therefore, the frame may experience a lower temperature during use.

The plurality of heating portions and the at least one attachment portion may be all integrally formed. Advantageously, this may simplify manufacturing and increase the robustness of the heating element.

Each attachment portion may be directly connected to exactly two heating portions. Each heating portion may be directly connected to exactly two attachment portions, or exactly one attachment portion and either the first electrical contact or the second electrical contact. Such an arrangement may advantageously provide an electrical pathway that is easy to manufacture to ensure that the cross sectional area of each heating portion perpendicular to the direction of the continuous electrical path may less than the cross sectional area of each attachment portion perpendicular to the direction of the continuous electrical path.

Each heating portion may have a first width in a first direction, and each attachment portion may have a second width in the first direction, and the second width may be greater than the first width. Advantageously, this provides an arrangement which ensures that the cross sectional area of each heating portion perpendicular to the direction of the continuous electrical path may less than the cross sectional area of each attachment portion perpendicular to the direction of the continuous electrical path, and is straightforward to manufacture by common manufacturing methods such as laser cutting, waterjet cutting or chemical etching stamping.

Each heating portion may extend perpendicular to the first direction. The first direction may lie in the first plane. The first direction may be perpendicular to the direction of the continuous electrical path when the direction of the continuous electrical path is defined by each heating portion. The ratio of the first width to the second width may be between 1/20 and ½. Preferably, the ratio of the first width to the second width is between 1/10 and ¼. The first width may be between 0.1 millimetres and 2 millimetres. Preferably, the first width is between 0.2 millimetres and 1 millimetre. More preferably, the first width is between 0.2 millimetres and 0.5 millimetres.

The heating element may have a thickness in at least one direction perpendicular to the first direction. The thickness may be between 0.02 millimetres and 0.5 millimetres. Preferably, the thickness is between 0.05 millimetres and 0.3 millimetres. Such dimensions may advantageously provide a heating element which is robust and can provide sufficient energy to heat an aerosol-forming substrate when the aerosol-generating device is a handheld device.

The heater assembly may comprise gaps between adjacent heating portions. The gaps may have a gap width. The gap width may be in the first direction. The gap width may be between 0.1 millimetres and 1 millimetre. Preferably, the gap width is between 0.2 millimetres and 0.5 millimetres.

The plurality of heating portions may comprise between 2 heating portions and 20 heating portions. Preferably, the plurality of heating portions comprises between 3 heating portions and 9 heating portions. Preferably still, the plurality of heating portions comprises 6 heating portions. Preferably, the plurality of heating portions comprises an even number of heating portions. Advantageously, an even number of heating portions means the first and second electrical contacts may be positioned on the same side of the heater assembly.

The electrical resistance per unit length in the direction of the electrically conductive path of the plurality of heating portions may be greater than the electrical resistance per unit length in the direction of the electrically conductive path of the at least one attachment portions. The electrical resistance per unit length may be measured by measuring the electrical resistance over each of the heating portions or attachment portions, and dividing the electrical resistance by the length of each of the heating portions or attachment portions in the direction of the electrically conductive path. The direction of the electrically conductive path may be a curve, for example, if the attachment portion is curved. The electrical resistance of each heating portion may be higher than the electrical resistance of each attachment portion.

The heater assembly may be configured such that when a non-zero voltage is applied across the heating element between the first and second electrical contacts, the temperatures of the plurality of heating portions increase more than the temperatures of the at least one attachment portions. The heater assembly may be configured such that when a non-zero current is applied through the heating element between the first and second electrical contacts, the temperatures of the plurality of heating portions increase more than the temperatures of the at least one attachment portions. In these cases, the temperatures of the plurality of heating portions and the temperatures of the at least one attachment portions may be average temperatures over the lengths of each of the plurality of heating portions the at least one attachment portions.

The heating element may be serpentine in shape. The heating element may be serpentine in shape in the first plane. The heating element may be serpentine in shape when projected onto the first plane. Advantageously, such arrangements allows for many heating portions to be positioned or packed within a reduced area. Additionally, the serpentine arrangement may be fluid permeable. The heater assembly may comprise spaces between heating portions of the heating element. Therefore the vapour generated by the heating element may pass through the serpentine heating element.

The heating element may comprise stainless steel. The heating element may comprise a ferrimagnetic or ferromagnetic material. Advantageously, the skin depth in a ferrimagnetic or a ferromagnetic material decreases when increasing the frequency of an alternating current applied to the heating element. The electrical resistance of the heating element increases as function of frequency. The use of ferrimagnetic or a ferromagnetic track may therefore allow for an in increase to its electrical resistance. This locally generates more heat, without reducing the thickness and compromising the mechanical strength of the heating element.

The heating element may be coated with a corrosion resistant material. In particular, the heating element may be coated with a ceramic material. Advantageously, this may increase the lifespan of the heating element, and the heater assembly. This is particularly relevant, as the heater assembly may be configured to be reversibly coupled with and decoupled from a wicking element, so the heater assembly may be configured to be reusable.

The heating element may be substantially flat. Advantageously, this may simplify manufacturing of the heating element.

The total resistance of the heating element may be between 0.1 Ohms and 5 Ohms. Preferably, the total resistance of the heating element is between 0.2 Ohms and 1.5 Ohms.

The heating element and the first and second electrical contacts may be integrally formed. The heating element and the first and second electrical contacts may be formed of the same material. Advantageously, these features may simplify manufacturing of the heating element.

The aperture may be substantially square or rectangular. Alternatively, the aperture may be substantially circular. Advantageously, such shapes for the aperture may ensure that a wicking element is easily aligned with the aperture when the aerosol-generating device is coupled to a cartridge. Additionally, such shapes may be simple to manufacture for the aperture or corresponding wicking element.

The frame may be electrically insulating. In particular, the frame may have a thermal conductivity of 1 W/mK or less. This may advantageously ensure that the electrical pathway through the heating element is well defined as a single electrical pathway, and minimise current flow through the frame, and hence resistive heating of the frame.

The frame may comprise a heat-resistant polymer. For example, the frame may comprise polyether ether ketone (PEEK). Alternatively, the frame may comprise a ceramic. For example, the frame may comprise alumina. In another example, the frame may comprise zirconia.

The frame may be overmoulded over a section of the heating element. For example, the frame may be overmoulded over an attachment section of the at least one attachment portions. Additionally or alternatively, the frame may be overmoulded over at least an attachment section of the first electrical contact and at least a section of the second electrical contact. Advantageously, overmoulding may provide a robust connection between the frame and the heating element.

The frame may comprise an upper element and a lower element. The upper element and the lower element may comprise press fit elements such that the upper element and the lower elements may be coupled together by press fitting. Alternatively, the upper element and the lower element may comprise snap fit elements such that the upper element and lower element may be coupled together by snap fitting. Alternatively, the upper element and the lower element May comprise fastening elements such that the upper element and lower element may be coupled together by fastening. Advantageously, the frame comprising an upper element and a lower element may provide for simplified manufacturing and a modular system wherein the heating element may be replaced, for example. At least an attachment section of the at least one attachment portions may be located between the upper element and the lower element when the upper element and lower element are coupled together. Additionally or alternatively, at least an attachment section of the first electrical contact and at least a section of the second electrical contact may be located between the upper element and the lower element when the upper element and lower element are coupled together. Advantageously, such arrangements ensure that the heating portions are not in contact with the frame.

The aperture may have a cross sectional area between 1 millimetre squared and 1000 millimetres squared in the first plane. Preferably, the aperture has a cross sectional area between 2 millimetres squared and 200 millimetres squared in the first plane. More preferably, the aperture has a cross sectional area between 4 millimetres squared and 50 millimetres squared in the first plane.

The heating element may further comprise at least one heat isolating portion. Each attachment portion may be separated from the frame by one heat isolating portion. Advantageously, heat isolating portions may further reduce the amount of heat transferred to the frame from the plurality of heating portions via the at least one attachment portions.

Each heating portion may be connected to the frame via at least one heat isolating portion.

The plurality of heating portions, the at least one attachment portions, and the at least one heat isolating portion may be all integrally formed. Advantageously, this simplifies manufacturing, as the heating element may be produced by common manufacturing methods such as laser cutting, waterjet cutting or chemical etching stamping.

Each heat isolating portion may be not directly attached to any heating portions. There may be an attachment portion intermediate each heat isolating portion and any heating portion. Each heat isolating portion may lie outside of the continuous electrical path. For example, each heat isolating portion may lie outside of the continuous electrical path such that the heat isolating portions undergo a lower increase in temperature due to direct resistive heating than both the increase in temperature of each attachment portion and the increase in temperature of each heating portion.

Each heat isolating portion may have a third width in the first direction. The third width may be smaller than the second width. The ratio of the third width to the second width may be between 1/10 and ⅔. Preferably, the ratio of the third width to the second width is between ⅕ and ⅓. The third width may be approximately equal to the first width. Advantageously, this provides a heat isolating portion which reduces the amount of heat transferred from the heating portions to the frame, whilst simplifying manufacturing.

The thermal resistance over each attachment portion between adjacent heating portions and adjacent heat isolating portions may be lower than the thermal resistance over each heat isolating portion between adjacent attachment portions and the frame. Thermal resistance may be defined a temperature difference by which an object or material resists a heat flow. The thermal resistance (R) over an attachment portion between adjacent heating portions and adjacent heat isolating portions may be defined as:

$$R = \frac{x}{A \cdot k}$$

wherein x is the length of each attachment portion measured between adjacent heating portions and adjacent heat isolating portions in the direction of a thermal pathway, A is the cross sectional area of each attachment portion in the direction of the thermal pathway between adjacent heating portions and adjacent heat isolating portions, and k is the thermal conductivity of each attachment portion, which is a material constant.

The thermal resistance over each heat isolating portion between adjacent attachment portions and the frame may be defined using an identical equation, wherein x is the length of each heat isolating portion measured between adjacent attachment portions and the frame in the direction of a thermal pathway, A is the cross sectional area of each heat isolating portion in the direction of the thermal pathway between adjacent attachment portions and the frame, and k is the thermal conductivity of each heat isolating portion, which is a material constant.

At least one heating portion may comprise a radius of curvature orthogonal to the first plane. At least one heating portion may comprise a finite radius of curvature orthogonal to the first plane. Each heating portion may comprise a radius of curvature orthogonal to the first plane. At least one heating portion may extend in a convex manner with respect to the direction from which a wicking element may be coupled to the heater assembly. At least one heating portion may comprise at least two sections which extend in at least two different directions not parallel to the first plane. At least one heating portion may extend in an arch out of the first plane. At least one heating portion may extend in a dome out of the first plane. At least one heating portion may curve out of the first plane. At least one heating portion may extend in an arcuate manner out of the first plane. At least one heating portion may comprise a radius of curvature orthogonal to the first plane such that when the at least one heating portion is reversibly deformed by a force such that the at least one heating portion lies parallel to the first plane, the reaction force exerted by the at least one heating portion is greater at the centre of the at least one heating portion than the reaction force exerted at a periphery of the at least one heating portion. Advantageously, when the aerosol-generating device is coupled to a cartridge such that the heater assembly is coupled to a wicking element, the heating element may therefore exert a greater force at the centre of a connecting surface of the wicking element than at a periphery of the connecting surface of the wicking element.

Each heating portion may comprise an identical radius of curvature orthogonal to the first plane. Alternatively, each heating portion may comprise a radius of curvature orthogonal to the first plane selected from a plurality of radii of curvature. For example, each heating portion may comprise a different radius of curvature orthogonal to the first plane.

The heater assembly may be configured such that when a wicking element is coupled to the heater assembly, the heating element exerts a force unevenly on a connecting surface of the wicking element. For example, the heating element may exert a greater force at the centre of the connecting surface of the wicking element than at the periphery of the connecting surface of the wicking element.

The heating element may comprise a resilient material. Advantageously, when the aerosol-generating device is coupled to a cartridge such that the heater assembly is coupled to a wicking element, the heating element may therefore undergo elastic deformation instead of fracturing.

The frame may comprise an upper surface parallel to the first plane. At least a first part of the heating element may recessed from the upper surface of the frame by a first distance. The first distance may be between 0.2 mm and 5 mm. Advantageously, such an arrangement may protect at least the first part of the heating element from damage, particularly if the heating element is uncovered and on an outer surface of an aerosol-generating device. An attachment section of the at least one attachment portions may be recessed from the upper surface of the frame by the first distance.

At least a second part of the heating element may coincide with a plane formed by the upper surface of the frame. Advantageously, such an arrangement means that the protrusion required of a wicking element is minimised, wherein the wicking element is configured to contact the heating element when a cartridge comprising a wicking element is coupled to an aerosol-generating device comprising the heater assembly. At least a second part of the heating element may coincide with a plane formed by the upper surface of the frame. At least a second part of the heating element may extend beyond the plane formed by the upper surface of the frame. The radius of curvature orthogonal to the first plane may be applied to the second part of the heating element.

Alternatively, the entire heating element may be recessed from the upper surface of the frame by the first distance. Advantageously, and as stated above, such an arrangement may protect the entire heating element from damage, particularly if the heating element is uncovered and on an outer surface of an aerosol-generating device.

The frame may comprise a lower surface parallel to the first plane. At least the first part of the heating element may be recessed from the lower surface of the frame by a second distance. The second distance may be between 0.2 mm and 5 mm.

An attachment section of the at least one attachment portions may be recessed from the lower surface of the frame by the second distance. Advantageously, such an arrangement may protect at least the at least one attachment portion from damage, particularly during handling of the heater assembly and assembly of an aerosol-generating device.

The heater assembly may further comprise a support structure. The frame may at least partially surround the support structure. The support structure may comprise a support structure aperture. The support structure aperture may lie in the first plane. The support structure aperture may be substantially circular. The support structure aperture may be substantially square or rectangular. The support structure aperture may be substantially oval in shape. The support structure may comprise a heat-resistant polymer. For example, the support structure may comprise polyether ether ketone (PEEK). Alternatively, the support structure may comprise a ceramic. For example, the support structure may comprise alumina. In another example, the support structure may comprise zirconia. The support structure may comprise the same material as the frame. Alternatively, the support structure may comprise a different material to the frame. The support structure aperture may have a cross sectional area between 1 millimetre squared and 1000 millimetres squared in the first plane. The support structure aperture may have a cross sectional area between 2 millimetres squared and 200 millimetres squared in the first plane Preferably, the support structure aperture has a cross sectional area between 4 millimetres squared and 50 millimetres squared in the first plane.

At least a portion of the heating element may be within the support structure aperture. In particular, the plurality of heating portions may be within the support structure aperture. At least a portion of the heating element may overlie the support structure aperture. In particular, the plurality of heating portions may overlie the support structure aperture. Advantageously, such features allow for aerosol to be easily transported from the heating element, where aerosol is generated, to a user.

The support structure may comprise an upper support structure surface parallel to the first plane. At least a part of the heating element may be co-planar with the upper support structure surface. The plurality of heating portions may be substantially co-planar with the upper support structure surface. Advantageously, such an arrangement means that the protrusion required of a wicking element is minimised, wherein the wicking element is configured to contact the heating element when a cartridge comprising a wicking element is coupled to an aerosol-generating device comprising the heater assembly.

Each attachment portion may comprise a first section and a second section. Each first section may be substantially coplanar with the upper support structure surface. Each second section may extend from the upper support structure surface towards a second plane. The second plane may be parallel but not co-planar with the upper support structure surface. Each second section may extend in a direction perpendicular to the upper support structure surface. Advantageously, this arrangement may provide a more robust structure for the heating element.

Each second section may be positioned between the frame and the support structure. Each second section may be secured between the frame and the support structure. Advantageously, each second section being positioned or secured between the frame and the support structure may result in a heating element which is firmly secured in place.

Both of the first and second electrical contacts may comprise a first electrical contact section and a second electrical contact section. Both first electrical contact sections may be substantially coplanar with the upper support structure surface. Both second electrical contact sections may extend from the upper support structure surface towards the second plane. Both second electrical contact sections may extend in a direction perpendicular to the upper support structure surface. Advantageously, this arrangement may provide a more robust structure for the heating element.

Both second electrical contact sections may be positioned between the frame and the support structure. Both second electrical contact sections may be secured between the frame and the support structure. Advantageously, both second electrical contact sections being positioned or secured between the frame and the support structure may result in a heating element which is firmly secured in place.

The frame may comprise an upper surface co-planar with the upper support structure surface. The frame may comprise a lower frame surface. The support structure may comprise a lower support structure surface co-planar with the lower surface of the frame. Each of the first and second electrical contacts may further comprise a third electrical contact section. Both third electrical contact sections may be substantially co-planar with the lower surface of the frame.

The plurality of heating portions may be co-planar with the upper surface of the frame.

According to a second embodiment of the present disclosure, there is provided an aerosol-generating device. The aerosol-generating device may comprise a heater assembly. The aerosol-generating device may comprise a heater assembly according to the first embodiment of the present disclosure. The heater assembly may comprise a heating element. The heater assembly may comprise a first electrical contact in electrical contact with a first end of the heating element. The heater assembly may comprise a second electrical contact in electrical contact with a second end of the heating element. The heating element may provide a continuous electrical path between the first electrical contact and the second electrical contact. The heating element may comprise a plurality of heating portions. The heating element may comprise at least one attachment portion positioned between heating portions along the continuous electrical path. The heater assembly may comprise a frame. The frame may comprise an aperture in a first plane. The heating element may be fixed to the frame. Each heating portion may be within the aperture. Each heating portion may overlie the aperture. Each heating portion may be separated from the frame by at least one attachment portion. The cross sectional area of each heating portion perpendicular to the direction of the continuous electrical path may be less than the cross sectional area of each attachment portion perpendicular to the direction of the continuous electrical path.

The aerosol-generating device may further comprise an air flow passage defined between an air inlet and an air outlet. The airflow passage may be in fluid communication with the heating element. In particular, the airflow passage may be in fluid communication with a first side of the heating element. The airflow passage may pass through the heater assembly. The heater assembly may comprise a heater assembly airflow passage between a heater assembly air inlet and a heater assembly air outlet. The aerosol-generating device may further comprise a power supply. The power supply may be in electrical contact with the first and second electrical contacts. The power supply may be configured to supply power to the heating element. The aerosol-generating device may further comprise control circuitry. The control circuitry may be configured to control the supply of power from the power supply to the heating element.

The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The control circuitry may be connected to the power source. The control circuitry may be connected to the heating element. The control circuitry may control the supply of power from the power source to the heating element. The control circuitry may control a temperature of the heating element. The control circuitry may comprise a controller. The control circuitry may comprise a microcontroller. The microcontroller may be a programmable microcontroller.

The aerosol-generating device may be a handheld aerosol-generating device. The aerosol-generating device may have a size comparable to a conventional cigar or cigarette. The aerosol-generating device may have a total length between about 25 mm and about 150 mm. The aerosol-generating device may have an external diameter between about 5 mm and about 30 mm.

The control circuitry may further comprise a puff detector in fluid communication with the airflow passage. The device may be configured such that the heating element is puff actuated. Advantageously, this may reduce energy consumption from the battery, and ensure that aerosol is only generated when desired by the user.

The air inlet may be defined in a side wall of the device. The air outlet may be defined in an end wall of the device. The air outlet may be defined in a proximal end wall of the device. Advantageously, the air outlet being defined in a proximal end wall of the device means that a cartridge comprising a mouthpiece may be easily coupled to the proximal end wall, and so easily couple to the air outlet. The side wall of the device may extend perpendicular to the end wall of the device.

According to a third embodiment of the present disclosure, there is provided an aerosol-generating system. The aerosol-generating system may comprise a cartridge. The cartridge may comprise an aerosol-forming substrate. The cartridge may comprise a reservoir containing the aerosol-forming substrate. The aerosol-forming substrate may be in fluid communication with a wicking material. The wicking material may form part of an external surface of the cartridge.

The aerosol-generating system may comprise an aerosol-generating device. The aerosol-generating system may comprise an aerosol-generating device according to the second embodiment of the present disclosure. The aerosol-generating device may comprise a heater assembly. The aerosol-generating device may comprise a heater assembly according to the first embodiment of the present disclosure. The heater assembly may comprise a heating element. The heater assembly may further comprise a first electrical contact in electrical contact with a first end of the heating element. The heater assembly may further comprise a second electrical contact in electrical contact with a second end of the heating element. The heating element may provide a continuous electrical path between the first electrical contact and the second electrical contact.

The heating element may comprise a plurality of heating portions. The heating element may further comprise at least one attachment portion. The at least one attachment portion may be positioned between heating portions along the continuous electrical path.

The heater assembly may comprise a frame. The frame may comprise an aperture. The frame may comprise an aperture in a first plane.

The heating element may be fixed to the frame. Each heating portion may be within the aperture. Each heating portion may overlie the aperture. Each heating portion may be separated from the frame by at least one attachment portion.

The cross sectional area of each heating portion perpendicular to the direction of the continuous electrical path may be less than the cross sectional area of each attachment portion perpendicular to the direction of the continuous electrical path.

The aerosol-generating system may comprise a system air flow passage defined between a system air inlet and a system air outlet. In particular, as in the second embodiment, the aerosol-generating device may further comprise an air flow passage defined between an air inlet and an air outlet. The system airflow passage may comprise the airflow passage of the device. The system air inlet may comprise the air inlet of the device. The system air outlet may comprise the air outlet of the deice. The airflow passage of the device may be in fluid communication with the heating element. In particular, the airflow passage of the device may be in fluid communication with a first side of the heating element. The system airflow passage may pass through the heater assembly. In particular, the airflow passage of the device may pass through the heater assembly. The heater assembly may comprise a heater assembly airflow passage between a heater assembly air inlet and a heater assembly air outlet. The air inlet of the device may comprise the heater assembly air inlet. The system airflow passage may comprise the heater assembly airflow passage. In particular, the airflow passage of the device may comprise the heater assembly airflow passage.

The aerosol-generating device may further comprise a power supply. The power supply may be in electrical contact with the first and second electrical contacts. The power supply may be configured to supply power to the heating element. The aerosol-generating device may further comprise control circuitry. The control circuitry may be configured to control the supply of power from the power supply to the heating element. Advantageously, the power supplied to the heating element may therefore be varied based on usage behaviours.

The cartridge may be reversibly couplable to the aerosol-generating device. The cartridge may be reversibly couplable to the aerosol-generating device such that when the cartridge is coupled to the device the wicking material is in direct contact with the heating element. Advantageously, the cartridge being reversibly couplable to the aerosol-generating device means that the cartridge may be disposed of once empty or damaged, and replaced by a new cartridge. This may save on costs and have an environmental benefit, as fewer components are being disposed of. The wicking element may have a cross sectional area equal to the cross sectional area of the aperture. The wicking element may have a cross sectional shape approximately identical to the cross sectional shape of the aperture.

The airflow passage of the aerosol-generating device may be in fluid communication with a first side of the heating element. When the cartridge is coupled to the device the wicking material may be in direct contact with a second side of the heating element. The first side of the heating element may be opposite to the second side of the heating element.

The cartridge may further comprise a cartridge air flow passage defined between an cartridge air inlet and a cartridge air outlet.

The cartridge may further comprise a removable seal covering a portion of the cartridge. In particular, the cartridge may further comprise a removable seal covering the wicking element. The removable seal may be configured to be removed by a user.

When the cartridge is coupled to the device, the cartridge air inlet may be in fluid communication with the air outlet of the device.

The cartridge air outlet may comprise a mouthpiece.

The aerosol-generating system may be a handheld aerosol-generating system configured to allow a user to suck on a mouthpiece to draw an aerosol through the cartridge air outlet. The aerosol-generating system may have a size comparable to a conventional cigar or cigarette. The aerosol-generating system may have a total length between about 25 mm and about 150 mm. The aerosol-generating system may have an external diameter between about 5 mm and about 30 mm.

The aerosol-forming substrate may be a liquid. In particular, the aerosol-forming substrate may be a liquid at standard temperature and pressure. Advantageously, this ensures that liquid aerosol-forming substrate may be easily transported from the reservoir to the wicking element, and then to the heating element when the system is used at standard temperature and pressure. The aerosol-forming substrate may be a liquid at room temperature. The aerosol-forming substrate may be in another condensed form, such as a solid at room temperature, or may be in another condensed form, such as a gel, at room temperature. Volatile compounds may be released by heating the aerosol-forming substrate. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

According to a fourth embodiment of the present disclosure, there is provided a cartridge for an aerosol-generating system. The cartridge may comprise an aerosol-forming substrate. The cartridge may comprise an aerosol-forming substrate as described in relation to the third embodiment. The aerosol-forming substrate may be in fluid communication with a wicking material.

The cartridge may comprise a heater assembly. The cartridge may comprise a heater assembly according to the first embodiment of the present disclosure. The cartridge may be configured to be coupled to an aerosol-generating device. The heater assembly may be couplable to and decouplable from a cartridge body. The heater assembly may comprise a heating element. The heater assembly may comprise a first electrical contact in electrical contact with a first end of the heating element. The heater assembly may comprise a second electrical contact in electrical contact with a second end of the heating element. The heating element may provide a continuous electrical path between the first electrical contact and the second electrical contact. The heating element may comprise a plurality of heating portions. The heating element may comprise at least one attachment portion positioned between heating portions along the continuous electrical path. The heater assembly may comprise a frame. The frame may comprise an aperture in a first plane. The heating element may be fixed to the frame. Each heating portion may be within the aperture. Each heating portion may overlie the aperture. Each heating portion may be separated from the frame by at least one attachment portion. The cross sectional area of each heating portion perpendicular to the direction of the continuous electrical path may be less than the cross sectional area of each attachment portion perpendicular to the direction of the continuous electrical path. The heater assembly may form part of an external surface of the cartridge. The wicking material may be in contact with the heating element.

The cartridge may further comprise a cartridge air flow passage. The cartridge airflow passage may be defined between an cartridge air inlet and a cartridge air outlet. The cartridge airflow passage may be in fluid communication with the heating element. In particular, the cartridge airflow passage may be in fluid communication with a first side of the heating element. The cartridge airflow passage may pass through the heater assembly. The heater assembly may comprise a heater assembly airflow passage between a heater assembly air inlet and a heater assembly air outlet. The cartridge air inlet may comprise the heater assembly air inlet.

The cartridge may be configured to be coupled to an aerosol-generating device. The cartridge may be configured to be coupled to an aerosol-generating device such that the cartridge air inlet aligns with a device air outlet of the aerosol-generating device.

The cartridge air outlet may comprise a mouthpiece.

The aerosol-forming substrate may be a liquid. In particular, the aerosol-forming substrate may be a liquid at standard temperature and pressure. Advantageously, this ensures that liquid aerosol-forming substrate may be easily transported from the reservoir to the wicking element, and then to the heating element when the system is used at standard temperature and pressure.

As used herein, the term “heating element” refers to an element of a heater assembly, the element being configured to be heated. For example, the term “heating element” may refer to an element configured for at least a portion of the element to be heated to at least 50, 100, 150, 200, 250, or 300 degrees Celsius.

As used herein, the term ‘coupled or couplable’ is used to mean that the cartridge and device can be coupled and uncoupled from one another and without significantly damaging either the device or cartridge.

As used herein, the term ‘serpentine’ is used to define a shape of a pathway which when viewed perpendicular to the plane of the pathway comprises at least one curve or bend of approximately 180 degrees in the pathway, such that a first area of the shape lies alongside a second area of the shape. The shape may therefore resemble a single Latin letter ‘S’, or multiple Latin letter ‘S’ connected end to end.

As used herein, the terms “air inlet’ and ‘air outlet” are used to describe one or more apertures through which air may be drawn into, and out of, respectively, of a component or portion of a component of the heater assembly, aerosol-generating system, cartridge or aerosol-generating device.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, an “aerosol-generating system” means a system that generates an aerosol from one or more aerosol-forming substrates.

As used herein, the term “aerosol-forming substrate” means a substrate capable of releasing volatile compounds that may form an aerosol. Such volatile compounds may be released by heating the aerosol-forming substrate.

The invention is defined in the claims. However, below there is provided a non-exhaustive list of non-limiting examples. Any one or more of the features of these examples may be combined with any one or more features of another example, embodiment, or aspect described herein.
Example Ex1. A heater assembly for an aerosol-generating device, the heater assembly comprising:
   a heating element,
   a first electrical contact in electrical contact with a first end of the heating element, and
   a second electrical contact in electrical contact with a second end of the heating element, the heating element providing a continuous electrical path between the first electrical contact and the second electrical contact;
   wherein the heating element comprises a plurality of heating portions and at least one attachment portion positioned between heating portions along the continuous electrical path,
   a frame comprising an aperture in a first plane,
   wherein the heating element is fixed to the frame and wherein each heating portion is within or overlies the aperture and is separated from the frame by at least one attachment portion, and
   wherein the cross sectional area of each heating portion perpendicular to the direction of the continuous electrical path is less than the cross sectional area of each attachment portion perpendicular to the direction of the continuous electrical path.
Example Ex2. A heater assembly according to Example Ex1, wherein the plurality of heating portions and the at least one attachment portion are all integrally formed.
Example Ex3. A heater assembly according to Example Ex1 or Ex2, wherein each attachment portion is directly connected to exactly two heating portions.
Example Ex4. A heater assembly according to any preceding claim, wherein each heating portion is directly connected to exactly two attachment portions, or exactly one attachment portion and either the first electrical contact or the second electrical contact.
Example Ex5. A heater assembly according to any preceding Example, wherein each heating portion has a first width in a first direction, wherein the first direction may be perpendicular to the direction of the continuous electrical path when the direction of the continuous electrical path is defined by each heating portion, and each attachment portion has a second width in the first direction, and wherein the second width is greater than the first width.
Example Ex6. A heater assembly according to Example Ex5, wherein the ratio of the first width to the second width is between 1/20 and ½.
Example Ex7. A heater assembly according to Example Ex6, wherein the ratio of the first width to the second width is between 1/10 and ¼.
Example Ex8. A heater assembly according to Example Ex5, Ex6 or Ex7, wherein the first width is between 0.1 millimetres and 2 millimetres.
Example Ex9. A heater assembly according to Example Ex8, wherein the first width is between 0.2 millimetres and 1 millimetre.
Example Ex10. A heater assembly according to Example Ex9, wherein the first width is between 0.2 millimetres and 0.5 millimetres.
Example Ex11. A heater assembly according to any of Examples Ex5 to Ex10, wherein the heating element has a thickness in at least one direction perpendicular to the first direction.
Example Ex12. A heater assembly according to Example Ex11, wherein the thickness is between 0.02 millimetres and 0.5 millimetres.
Example Ex13. A heater assembly according to Example Ex12, wherein the thickness is between 0.05 millimetres and 0.3 millimetres.
Example Ex14. A heater assembly according to any preceding Example, wherein the electrical resistance per unit length in the direction of the electrically conductive path of the plurality of heating portions is greater than the electrical resistance per unit length in the direction of the electrically conductive path of the at least one attachment portions.
Example Ex15. A heater assembly according to any of Examples Ex1 to Ex13, wherein the electrical resistance of each heating portion is higher than the electrical resistance of each attachment portion.
Example Ex16. A heater assembly according to any preceding Example, wherein the heater assembly is configured such that when a non-zero voltage is applied across the heating element between the first and second electrical contacts, the temperatures of the plurality of heating portions increase more than the temperatures of the at least one attachment portions.
Example Ex17. A heater assembly according to any preceding Example, wherein the heating element is serpentine in shape.
Example Ex18. A heater assembly according to any preceding Example, wherein the heating element comprises stainless steel.
Example Ex19. A heater assembly according to any preceding Example, wherein the heating element comprises a ferrimagnetic or ferromagnetic material.
Example Ex20. A heater assembly according to any preceding Example, wherein the heating element is coated with a corrosion resistant material.
Example Ex21. A heater assembly according to any preceding Example, wherein the heating element is coated with a ceramic material.
Example Ex22. A heater assembly according to any preceding Example, wherein the heating element is substantially flat.
Example Ex23. A heater assembly according to any preceding Example, wherein the total resistance of the heating element is between 0.1 Ohms and 5 Ohms.
Example Ex24. A heater assembly according to Example Ex23, wherein the total resistance of the heating element is between 0.2 Ohms and 1.5 Ohms.
Example Ex25. A heater assembly according to any preceding Example, wherein the heating element and the first and second electrical contacts are integrally formed.
Example Ex26. A heater assembly according to any preceding Example, wherein the heating element and the first and second electrical contacts are formed of the same material.
Example Ex27. A heater assembly according to any preceding Example, wherein the aperture is substantially square or rectangular.
Example Ex28. A heater assembly according to any preceding Example, wherein the aperture is substantially circular.
Example Ex29. A heater assembly according to any preceding Example, wherein the frame is electrically insulating.
Example Ex30. A heater assembly according to Example Ex29, wherein the frame has a thermal conductivity of 1 W/mK or less.
Example Ex31. A heater assembly according to Example Ex29 or Ex30, wherein the frame comprises a heat-resistant polymer.
Example Ex32. A heater assembly according to any of Examples Ex29 to Ex31, wherein the frame comprises polyether ether ketone (PEEK).
Example Ex33. A heater assembly according to Example Ex29 or Ex30, wherein the frame comprises a ceramic.
Example Ex34. A heater assembly according to Example Ex33, wherein the frame comprises alumina.
Example Ex35. A heater assembly according to Example Ex33, wherein the frame comprises zirconia.
Example Ex36. A heater assembly according to any preceding Example, wherein the frame is overmoulded over a section of the heating element.
Example Ex37. A heater assembly according to Example Ex36, wherein the frame is overmoulded over an attachment section of the at least one attachment portions.
Example Ex38. A heater assembly according to any preceding Example, wherein the frame is overmoulded over at least an attachment section of the first electrical contact and at least a section of the second electrical contact.
Example Ex39. A heater assembly according to any of Examples Ex1 to Ex35, wherein the frame comprises an upper element and a lower element.
Example Ex40. A heater assembly according to Example Ex39, wherein the upper element and the lower element comprise press fit elements such that the upper element and the lower elements may be coupled together by press fitting.
Example Ex41. A heater assembly according to Example Ex39, wherein the upper element and the lower element comprise snap fit elements such that the upper element and lower element may be coupled together by snap fitting.
Example Ex42. A heater assembly according to Example Ex40 or Ex41, wherein at least an attachment section of the at least one attachment portions is located between the upper element and the lower element when the upper element and lower element are coupled together.
Example Ex43. A heater assembly according to any of Examples Ex40 to Ex42, wherein at least an attachment section of the first electrical contact and at least a section of the second electrical contact is located between the upper element and the lower element when the upper element and lower element are coupled together.
Example Ex44. A heater assembly according to any preceding Example, wherein the aperture has a cross sectional area between 1 millimetres squared and 1000 millimetres squared in the first plane.
Example Ex45. A heater assembly according to Example Ex44, wherein the aperture has a cross sectional area between 2 millimetres squared and 200 millimetres squared in the first plane.
Example Ex46. A heater assembly according to Example Ex45, wherein the aperture has a cross sectional area between 4 millimetres squared and 50 millimetres squared in the first plane.
Example Ex47. A heater assembly according to any preceding Example, wherein the heating element further comprises at least one heat isolating portion, and wherein each attachment portion is separated from the frame by one heat isolating portion.

Example Ex48. A heater assembly according to Example Ex47, wherein each heating portion is connected to the frame via at least one heat isolating portion.
Example Ex49. A heater assembly according to Example Ex47 or Ex48, wherein the plurality of heating portions, the at least one attachment portions, and the at least one heat isolating portion are all integrally formed.
Example Ex50. A heater assembly according to any of Examples Ex47 to Ex49 when dependent on Example Ex5, wherein each heat isolating portion has a third width in the first direction, and wherein the third width is smaller than the second width.
Example Ex51. A heater assembly according to Example Ex50, wherein the ratio of the third width to the second width is between 1/10 and ⅔.
Example Ex52. A heater assembly according to Example Ex51, wherein the ratio of the third width to the second width is between ⅕ and ⅓.
Example Ex53. A heater assembly according any of Examples Ex50 to Ex52, wherein the third width is approximately equal to the first width.
Example Ex54. A heater assembly according to any of Examples Ex47 to Ex53, wherein the thermal resistance over each attachment portion between adjacent heating portions and adjacent heat isolating portions is lower than the thermal resistance over each heat isolating portion between adjacent attachment portions and the frame.
Example Ex55. A heater assembly according to any preceding Example, wherein each heating portion comprises a radius of curvature orthogonal to the first plane.
Example Ex56. A heater assembly according to any preceding Example, wherein the heating element comprises a resilient material.
Example Ex57. A heater assembly according to any preceding Example, wherein the frame comprises an upper surface parallel to the first plane, and at least a first part of the heating element is recessed from the upper surface of the frame by a first distance.
Example Ex58. A heater assembly according to Example Ex57, wherein the first distance is between 0.2 mm and 5 mm.
Example Ex59. A heater assembly according to Example Ex57 or Ex58, wherein an attachment section of the at least one attachment portions is recessed from the upper surface of the frame by the first distance.
Example Ex60. A heater assembly according to any of Examples Ex57 to Ex59, wherein at least a second part of the heating element coincides with a plane formed by the upper surface of the frame.
Example Ex61. A heater assembly according to any of Examples Ex57 to Ex59, wherein the entire heating element is recessed from the upper surface of the frame by the first distance.
Example Ex62. A heater assembly according to any of Examples Ex57 to Ex61, wherein the frame comprises a lower surface parallel to the first plane, and at least the first part of the heating element is recessed from the lower surface of the frame by a second distance.
Example Ex63. A heater assembly according to Example Ex62, wherein the second distance is between 0.2 mm and 5 mm.
Example Ex64. A heater assembly according to Example Ex62 or Ex63, wherein an attachment section of the at least one attachment portions is recessed from the lower surface of the frame by the second distance.
Example Ex65. A heater assembly according to any preceding Example, further comprising a support structure, wherein the frame at least partially surrounds the support structure, and wherein the support structure comprises a support structure aperture.
Example Ex66. A heater assembly according to Example Ex65, wherein at least a portion of the heating element is within or overlies the support structure aperture.
Example Ex67. A heater assembly according to Example Ex66, wherein the plurality of heating portions is within or overlies the support structure aperture.
Example Ex68. A heater assembly according to any of Examples Ex65 to Ex67, wherein the support structure comprises an upper support structure surface parallel to the first plane, and at least a part of the heating element is co-planar with the upper support structure surface.
Example Ex69. A heater assembly according to Example Ex68, wherein the plurality of heating portions are co-planar with the upper support structure surface.
Example Ex70. A heater assembly according to Example Ex68 or Ex69, wherein each attachment portion comprises a first section and a second section, and wherein each first section is substantially coplanar with the upper support structure surface, and each second section extends from the upper support structure surface towards a second plane, the second plane being parallel but not co-planar with the upper support structure surface.
Example Ex71. A heater assembly according to Example Ex70, wherein each second section extends in a direction perpendicular to the upper support structure surface.
Example Ex72. A heater assembly according to Example Ex70 or Ex71, wherein each second section is positioned between the frame and the support structure.
Example Ex73. A heater assembly according to any of Examples Ex68 to Ex72, wherein both of the first and second electrical contacts comprise a first electrical contact section and a second electrical contact section, and wherein both first electrical contact sections are substantially coplanar with the upper support structure surface, and both second electrical contact sections extend from the upper support structure surface towards the second plane.
Example Ex74. A heater assembly according to Example Ex73, wherein both second electrical contact sections extend in a direction perpendicular to the upper support structure surface.
Example Ex75. A heater assembly according to Example Ex73 or Ex74, wherein both second electrical contact sections are positioned between the frame and the support structure.
Example Ex76. A heater assembly according to any of Examples Ex68 to Ex75, wherein the frame comprises an upper surface co-planar with the upper support structure surface.
Example Ex77. A heater assembly according to any of Examples Ex68 to Ex76, wherein the frame comprises a lower frame surface and wherein the support structure comprises a lower support structure surface co-planar with the lower surface of the frame, wherein each of the first and second electrical contacts further comprise a third electrical contact section, and wherein both third electrical contact sections are substantially co-planar with the lower surface of the frame.
Example Ex78. A heater assembly according to any of Examples Ex74 to Ex77, wherein the plurality of heating portions are co-planar with the upper surface of the frame.
Example Ex79. An aerosol-generating device comprising:
   a heater assembly, the heater assembly comprising:
      a heating element,
      a first electrical contact in electrical contact with a first end of the heating element, and
      a second electrical contact in electrical contact with a second end of the heating element, the heating element providing a continuous electrical path between the first electrical contact and the second electrical contact;
      wherein the heating element comprises a plurality of heating portions and at least one attachment portion positioned between heating portions along the continuous electrical path,
      a frame comprising an aperture in a first plane,
      wherein the heating element is fixed to the frame and wherein each heating portion is within or overlies the aperture and is separated from the frame by at least one attachment portion, and
      wherein the cross sectional area of each heating portion perpendicular to the direction of the continuous electrical path is less than the cross sectional area of each attachment portion perpendicular to the direction of the continuous electrical path,
   an air flow passage defined between an air inlet and an air outlet, the airflow passage in fluid communication with the heating element,
   a power supply, the power supply in electrical contact with the first and second electrical contacts and configured to supply power to the heating element, and
   control circuitry, the control circuitry configured to control the supply of power from the power supply to the heating element.
Example Ex80. An aerosol-generating device according to Example Ex79, wherein the wherein the aerosol-generating device is a handheld aerosol-generating device.
Example Ex81. An aerosol-generating device according to Example Ex79 or Ex80, wherein the control circuitry further comprises a puff detector in fluid communication with the airflow passage, and the device is configured such that the heating element is puff actuated.
Example Ex82. An aerosol-generating device according to any of Examples Ex79 to Ex81, wherein the air inlet is defined in a side wall of the device.
Example Ex83. An aerosol-generating device according to Example Ex82, wherein the air outlet is defined in an end wall of the device.
Example Ex84. An aerosol-generating device according to Example Ex83, wherein the side wall of the device extends perpendicular to the end wall of the device.
Example Ex85. An aerosol-generating device according to any of Examples Ex79 to Ex84, wherein the plurality of heating portions and the at least one attachment portion are all integrally formed.
Example Ex86. An aerosol-generating device according to any of Examples Ex79 to Ex85, wherein each attachment portion is directly connected to exactly two heating portions.
Example Ex87. An aerosol-generating device according to any of Examples Ex79 to Ex86, wherein each heating portion is directly connected to exactly two attachment portions, or exactly one attachment portion and either the first electrical contact or the second electrical contact.
Example Ex88. An aerosol-generating device according to any of Examples Ex79 to Ex87, wherein each heating portion has a first width in a first direction, and each attachment portion has a second width in the first direction, and wherein the second width is greater than the first width.
Example Ex89. An aerosol-generating device according to Example Ex88, wherein the ratio of the first width to the second width is between 1/20 and ½.
Example Ex90. An aerosol-generating device according to Example Ex89, wherein the ratio of the first width to the second width is between 1/10 and ¼.
Example Ex91. An aerosol-generating device according to Example Ex88, Ex89 or Ex90, wherein the first width is between 0.1 millimetres and 2 millimetres.
Example Ex92. An aerosol-generating device according to Example Ex91, wherein the first width is between 0.2 millimetres and 1 millimetre.
Example Ex93. An aerosol-generating device according to Example Ex92, wherein the first width is between 0.2 millimetres and 0.5 millimetres.
Example Ex94. An aerosol-generating device according to any of Examples Ex79 to Ex93, wherein the heating element has a thickness in at least one direction perpendicular to the first direction.
Example Ex95. An aerosol-generating device according to Example Ex93, wherein the thickness is between 0.02 millimetres and 0.5 millimetres.
Example Ex96. An aerosol-generating device according to Example Ex95, wherein the thickness is between 0.05 millimetres and 0.3 millimetres.
Example Ex97. An aerosol-generating device according to any of Examples Ex79 to Ex96, wherein the electrical resistance per unit length in the direction of the electrically conductive path of the plurality of heating portions is greater than the electrical resistance per unit length in the direction of the electrically conductive path of the at least one attachment portions.
Example Ex98. An aerosol-generating device according to any of Examples Ex79 to Ex97, wherein the electrical resistance of each heating portion is higher than the electrical resistance of each attachment portion.
Example Ex99. An aerosol-generating device according to any of Examples Ex79 to Ex98, wherein the heater assembly is configured such that when a non-zero voltage is applied across the heating element between the first and second electrical contacts, the temperatures of the plurality of heating portions increase more than the temperatures of the at least one attachment portions.
Example Ex100. An aerosol-generating device according to any of Examples Ex79 to Ex99, wherein the heating element is serpentine in shape.
Example Ex101. An aerosol-generating device according to any of Examples Ex79 to Ex100, wherein the heating element comprises stainless steel.
Example Ex102. An aerosol-generating device according to any of Examples Ex79 to Ex101, wherein the heating element comprises a ferrimagnetic or ferromagnetic material.
Example Ex103. An aerosol-generating device according to any of Examples Ex79 to Ex102, wherein the heating element is coated with a corrosion resistant material.
Example Ex104. An aerosol-generating device according to any of Examples Ex79 to Ex103, wherein the heating element is coated with a ceramic material.
Example Ex105. An aerosol-generating device according to any of Examples Ex79 to Ex104, wherein the heating element is substantially flat.
Example Ex106. An aerosol-generating device according to any of Examples Ex79 to Ex105, wherein the total resistance of the heating element is between 0.1 Ohms and 5 Ohms.
Example Ex107. An aerosol-generating device according to Example Ex106, wherein the total resistance of the heating element is between 0.2 Ohms and 1.5 Ohms.
Example Ex108. An aerosol-generating device according to any of Examples Ex79 to Ex107, wherein the heating element and the first and second electrical contacts are integrally formed.
Example Ex109. An aerosol-generating device according to any of Examples Ex79 to Ex108, wherein the heating element and the first and second electrical contacts are formed of the same material.
Example Ex110. An aerosol-generating device according to any of Examples Ex79 to Ex109, wherein the aperture is substantially square or rectangular.
Example Ex111. An aerosol-generating device according to any of Examples Ex79 to Ex110, wherein the aperture is substantially circular.
Example Ex112. An aerosol-generating device according to any of Examples Ex79 to Ex111, wherein the frame is electrically insulating.
Example Ex113. An aerosol-generating device according to Example Ex112, wherein the frame has a thermal conductivity of 1 W/mK or less.
Example Ex114. An aerosol-generating device according to Example Ex112 or Ex113, wherein the frame comprises a heat-resistant polymer.
Example Ex115. An aerosol-generating device according to any of Examples Ex112 to Ex114, wherein the frame comprises polyether ether ketone (PEEK).
Example Ex116. An aerosol-generating device according to Example Ex112 or Ex113, wherein the frame comprises a ceramic.
Example Ex117. An aerosol-generating device according to Example Ex116, wherein the frame comprises alumina.
Example Ex118. An aerosol-generating device according to Example Ex116, wherein the frame comprises zirconia.
Example Ex119. An aerosol-generating device according to any of Examples Ex79 to Ex118, wherein the frame is overmoulded over a section of the heating element.
Example Ex120. An aerosol-generating device according to Example Ex119, wherein the frame is overmoulded over an attachment section of the at least one attachment portions.
Example Ex121. An aerosol-generating device according to any of Examples Ex79 to Ex120, wherein the frame is overmoulded over at least an attachment section of the first electrical contact and at least a section of the second electrical contact.
Example Ex122. An aerosol-generating device according to any of Examples Ex79 to Ex118, wherein the frame comprises an upper element and a lower element.
Example Ex123. An aerosol-generating device according to Example Ex122, wherein the upper element and the lower element comprise press fit elements such that the upper element and the lower elements may be coupled together by press fitting.
Example Ex124. An aerosol-generating device according to Example Ex122, wherein the upper element and the lower element comprise snap fit elements such that the upper element and lower element may be coupled together by snap fitting.
Example Ex125. An aerosol-generating device according to Example Ex123 or Ex124, wherein at least an attachment section of the at least one attachment portions is located between the upper element and the lower element when the upper element and lower element are coupled together.
Example Ex126. An aerosol-generating device according to any of Examples Ex123 to Ex125, wherein at least an attachment section of the first electrical contact and at least a section of the second electrical contact is located between the upper element and the lower element when the upper element and lower element are coupled together.
Example Ex127. An aerosol-generating device according to any of Examples Ex79 to Ex126, wherein the aperture has a cross sectional area between 1 millimetre squared and 1000 millimetres squared in the first plane.
Example Ex128. An aerosol-generating device according to Example Ex127, wherein the aperture has a cross sectional area between 2 millimetres squared and 200 millimetres squared in the first plane.
Example Ex129. An aerosol-generating device according to Example Ex128, wherein the aperture has a cross sectional area between 4 millimetres squared and 50 millimetres squared in the first plane.
Example Ex130. An aerosol-generating device according to any of Examples Ex79 to Ex129, wherein the heating element further comprises at least one heat isolating portion, and wherein each attachment portion is separated from the frame by one heat isolating portion.
Example Ex131. An aerosol-generating device according to Example Ex130, wherein each heating portion is connected to the frame via at least one heat isolating portion.
Example Ex132. An aerosol-generating device according to Example EX130 or Ex131, wherein the plurality of heating portions, the at least one attachment portions, and the at least one heat isolating portion are all integrally formed.
Example Ex133. An aerosol-generating device according to any of Examples Ex130 to Ex132 when dependent on Example Ex88, wherein each heat isolating portion has a third width in the first direction, and wherein the third width is smaller than the second width.
Example Ex134. An aerosol-generating device according to Example Ex133, wherein the ratio of the third width to the second width is between 1/10 and ⅔.
Example Ex135. An aerosol-generating device according to Example Ex134, wherein the ratio of the third width to the second width is between ⅕ and ⅓.
Example Ex136. A heater assembly according any of Examples Ex133 to E135, wherein the third width is approximately equal to the first width.
Example Ex137. An aerosol-generating device according to any of Examples Ex130 to Ex136, wherein the thermal resistance over each attachment portion between adjacent heating portions and adjacent heat isolating portions is lower than the thermal resistance over each heat isolating portion between adjacent attachment portions and the frame.
Example Ex138. An aerosol-generating device according to any of Examples Ex79 to Ex137, wherein each heating portion comprises a radius of curvature orthogonal to the first plane.
Example Ex139. An aerosol-generating device according to any of Examples Ex79 to Ex138, wherein the heating element comprises a resilient material.
Example Ex140. An aerosol-generating device according to any of Examples Ex79 to Ex139, wherein the frame comprises an upper surface parallel to the first plane, and at least a first part of the heating element is recessed from the upper surface of the frame by a first distance.
Example Ex141. An aerosol-generating device according to Example Ex140 wherein the first distance is between 0.2 mm and 5 mm.
Example Ex142. An aerosol-generating device according to Example Ex140 or Ex141, wherein an attachment section of the at least one attachment portions is recessed from the upper surface of the frame by the first distance.
Example Ex143. An aerosol-generating device according to any of Examples Ex140 to Ex142, wherein at least a second part of the heating element coincides with a plane formed by the upper surface of the frame.
Example Ex144. An aerosol-generating device according to any of Examples Ex140 to Ex142, wherein the entire heating element is recessed from the upper surface of the frame by the first distance.
Example Ex145. An aerosol-generating device according to any of Examples Ex140 to Ex144, wherein the frame comprises a lower surface parallel to the first plane, and at least the first part of the heating element is recessed from the lower surface of the frame by a second distance.
Example Ex146. An aerosol-generating device according to Example Ex145, wherein the second distance is between 0.2 mm and 5 mm.
Example Ex147. An aerosol-generating device according to Example Ex145 or Ex146, wherein an attachment section of the at least one attachment portions is recessed from the lower surface of the frame by the second distance.
Example Ex148. An aerosol-generating device according to any of Examples Ex79 to Ex147, further comprising a support structure, wherein the frame at least partially surrounds the support structure, and wherein the support structure comprises a support structure aperture.
Example Ex149. An aerosol-generating device according to Example Ex148, wherein at least a portion of the heating element is within or overlies the support structure aperture.
Example Ex150. An aerosol-generating device according to Example Ex149, wherein the plurality of heating portions is within or overlies the support structure aperture.
Example Ex151. An aerosol-generating device according to any of Examples Ex148 to Ex150, wherein the support structure comprises an upper support structure surface parallel to the first plane, and at least a part of the heating element is co-planar with the upper support structure surface.
Example Ex152. An aerosol-generating device according to Example Ex151, wherein the plurality of heating portions are co-planar with the upper support structure surface.
Example Ex153. An aerosol-generating device according to Example Ex151 or Ex152, wherein each attachment portion comprises a first section and a second section, and wherein each first section is substantially coplanar with the upper support structure surface, and each second section extends from the upper support structure surface towards a second plane, the second plane being parallel but not co-planar with the upper support structure surface.
Example Ex154. An aerosol-generating device according to Example Ex153, wherein each second section extends in a direction perpendicular to the upper support structure surface.
Example Ex155. An aerosol-generating device according to Example Ex153 or Ex154, wherein each second section is positioned between the frame and the support structure.
Example Ex156. An aerosol-generating device according to any of Examples Ex151 to Ex155, wherein both of the first and second electrical contacts comprise a first electrical contact section and a second electrical contact section, and wherein both first electrical contact sections are substantially coplanar with the upper support structure surface, and both second electrical contact sections extend from the upper support structure surface towards the second plane.
Example Ex157. An aerosol-generating device according to Example Ex156, wherein both second electrical contact sections extend in a direction perpendicular to the upper support structure surface.
Example Ex158. An aerosol-generating device according to Example Ex156 or Ex157, wherein both second electrical contact sections are positioned between the frame and the support structure.
Example Ex159. An aerosol-generating device according to any of Examples Ex151 to Ex158, wherein the frame comprises an upper surface co-planar with the upper support structure surface.
Example Ex160. An aerosol-generating device according to any of Examples Ex151 to Ex159, wherein the frame comprises a lower frame surface and wherein the support structure comprises a lower support structure surface co-planar with the lower surface of the frame, wherein each of the first and second electrical contacts further comprise a third electrical contact section, and wherein both third electrical contact sections are substantially co-planar with the lower surface of the frame.
Example Ex161. An aerosol-generating device according to any of Examples Ex157 to Ex160, wherein the plurality of heating portions are co-planar with the upper surface of the frame.
Example Ex162. An aerosol-generating system comprising:
   a cartridge, the cartridge comprising;
      an aerosol-forming substrate in fluid communication with a wicking material,
      wherein the wicking material forms part of an external surface of the cartridge, and
   an aerosol-generating device, the aerosol-generating device comprising:
      a heater assembly, the heater assembly comprising:
      a heating element,
      a first electrical contact in electrical contact with a first end of the heating element, and
      a second electrical contact in electrical contact with a second end of the heating element, the heating element providing a continuous electrical path between the first electrical contact and the second electrical contact;
      wherein the heating element comprises a plurality of heating portions and at least one attachment portion positioned between heating portions along the continuous electrical path,
      a frame comprising an aperture in a first plane,
      wherein the heating element is fixed to the frame and wherein each heating portion is within or overlies the aperture and is separated from the frame by at least one attachment portion, and
      wherein the cross sectional area of each heating portion perpendicular to the direction of the continuous electrical path is less than the cross sectional area of each attachment portion perpendicular to the direction of the continuous electrical path,
      an air flow passage defined between an air inlet and an air outlet, the airflow passage in fluid communication with the heating element,
      a power supply, the power supply in electrical contact with the first and second electrical contacts and configured to supply power to the heating element, and control circuitry, the control circuitry configured to control the supply of power from the power supply to the heating element,
   wherein the cartridge is reversibly couplable to the aerosol-generating device, such that when the cartridge is coupled to the device the wicking material is in direct contact with the heating element.
Example Ex163. An aerosol-generating system according to Example Ex162, wherein the airflow passage is in fluid communication with a first side of the heating element, and when the cartridge is coupled to the device the wicking material is in direct contact with a second side of the heating element.
Example Ex164. An aerosol-generating system according to Example Ex162 or Ex163, wherein the cartridge further comprises a cartridge air flow passage defined between an cartridge air inlet and a cartridge air outlet.
Example Ex165. An aerosol-generating system according to Example Ex164, wherein when the cartridge is coupled to the device, the cartridge air inlet is in fluid communication with the air outlet of the device.
Example Ex166. An aerosol-generating system according to Example Ex164 or Ex165, wherein the cartridge air outlet comprises a mouthpiece.
Example Ex167. An aerosol-generating system according to any of Examples Ex162 to Ex166, wherein the aerosol-forming substrate is a liquid at standard temperature and pressure.
Example Ex168. An aerosol-generating system according to any of Examples Ex162 to Ex 167, wherein the plurality of heating portions and the at least one attachment portion are all integrally formed.
Example Ex169. An aerosol-generating system according to any of Examples Ex162 to Ex 168, wherein each attachment portion is directly connected to exactly two heating portions.
Example Ex170. An aerosol-generating system according to any of Examples Ex162 to Ex 169, wherein each heating portion is directly connected to exactly two attachment portions, or exactly one attachment portion and either the first electrical contact or the second electrical contact.
Example Ex171. An aerosol-generating system according to any of Examples Ex162 to Ex 170, wherein each heating portion has a first width in a first direction, and each attachment portion has a second width in the first direction, and wherein the second width is greater than the first width.
Example Ex172. An aerosol-generating system according to Example Ex171, wherein the ratio of the first width to the second width is between 1/20 and ½.
Example Ex173. An aerosol-generating system according to Example Ex172, wherein the ratio of the first width to the second width is between 1/10 and ¼.
Example Ex174. An aerosol-generating system according to Example Ex171, Ex172 or Ex173, wherein the first width is between 0.1 millimetres and 2 millimetres.
Example Ex175. An aerosol-generating system according to Example Ex174, wherein the first width is between 0.2 millimetres and 1 millimetre.
Example Ex176. An aerosol-generating system according to Example Ex175, wherein the first width is between 0.2 millimetres and 0.5 millimetres.
Example Ex177. An aerosol-generating system according to any of Examples Ex162 to Ex 176, wherein the heating element has a thickness in at least one direction perpendicular to the first direction.
Example Ex178. An aerosol-generating system according to Example Ex177, wherein the thickness is between 0.02 millimetres and 0.5 millimetres.
Example Ex179. An aerosol-generating system according to Example Ex178, wherein the thickness is between 0.05 millimetres and 0.3 millimetres.
Example Ex180. An aerosol-generating system according to any of Examples Ex162 to Ex 179, wherein the electrical resistance per unit length in the direction of the electrically conductive path of the plurality of heating portions is greater than the electrical resistance per unit length in the direction of the electrically conductive path of the at least one attachment portions.
Example Ex181. An aerosol-generating system according to any of Examples Ex162 to Ex 180, wherein the electrical resistance of each heating portion is higher than the electrical resistance of each attachment portion.
Example Ex182. An aerosol-generating system according to any of Examples Ex162 to Ex 181, wherein the heater assembly is configured such that when a non-zero voltage is applied across the heating element between the first and second electrical contacts, the temperatures of the plurality of heating portions increase more than the temperatures of the at least one attachment portions.
Example Ex183. An aerosol-generating system according to any of Examples Ex162 to Ex 182, wherein the heating element is serpentine in shape.
Example Ex184. An aerosol-generating system according to any of Examples Ex162 to Ex 183, wherein the heating element comprises stainless steel.
Example Ex185. An aerosol-generating system according to any of Examples Ex162 to Ex 184, wherein the heating element comprises a ferrimagnetic or ferromagnetic material.
Example Ex186. An aerosol-generating system according to any of Examples Ex162 to Ex 185, wherein the heating element is coated with a corrosion resistant material.
Example Ex187. An aerosol-generating system according to any of Examples Ex162 to Ex 186, wherein the heating element is coated with a ceramic material.
Example Ex188. An aerosol-generating system according to any of Examples Ex162 to Ex 187, wherein the heating element is substantially flat.
Example Ex189. An aerosol-generating system according to any of Examples Ex162 to Ex 188, wherein the total resistance of the heating element is between 0.1 Ohms and 5 Ohms.
Example Ex190. An aerosol-generating system according to Example Ex189, wherein the total resistance of the heating element is between 0.2 Ohms and 1.5 Ohms.
Example Ex191. An aerosol-generating system according to any of Examples Ex162 to Ex 190, wherein the heating element and the first and second electrical contacts are integrally formed.
Example Ex192. An aerosol-generating system according to any of Examples Ex162 to Ex 191, wherein the heating element and the first and second electrical contacts are formed of the same material.
Example Ex193. An aerosol-generating system according to any of Examples Ex162 to Ex 192, wherein the aperture is substantially square or rectangular.
Example Ex194. An aerosol-generating system according to any of Examples Ex162 to Ex 193, wherein the aperture is substantially circular.
Example Ex195. An aerosol-generating system according to any of Examples Ex162 to Ex 194, wherein the frame is electrically insulating.
Example Ex196. An aerosol-generating system according to Example Ex195, wherein the frame has a thermal conductivity of 1 W/mK or less.
Example Ex197. An aerosol-generating system according to Example Ex195 or Ex196, wherein the frame comprises a heat-resistant polymer.
Example Ex198. An aerosol-generating system according to any of Examples Ex195 to Ex197, wherein the frame comprises polyether ether ketone (PEEK).
Example Ex199. An aerosol-generating system according to Example Ex195 or Ex196, wherein the frame comprises a ceramic.
Example Ex200. An aerosol-generating system according to Example Ex195 or Ex196, wherein the frame comprises alumina.
Example Ex201. An aerosol-generating system according to Example Ex200, wherein the frame comprises zirconia.
Example Ex202. An aerosol-generating system according to any of Examples Ex162 to Ex 201, wherein the frame is overmoulded over a section of the heating element.
Example Ex203. An aerosol-generating system according to Example Ex202, wherein the frame is overmoulded over an attachment section of the at least one attachment portions.
Example Ex204. An aerosol-generating system according to any of Examples Ex162 to Ex 203, wherein the frame is overmoulded over at least an attachment section of the first electrical contact and at least a section of the second electrical contact.
Example Ex205. An aerosol-generating system according to any of Examples Ex162 to Ex 201, wherein the frame comprises an upper element and a lower element.
Example Ex206. An aerosol-generating system according to Example Ex205, wherein the upper element and the lower element comprise press fit elements such that the upper element and the lower elements may be coupled together by press fitting.
Example Ex207. An aerosol-generating system according to Example Ex205, wherein the upper element and the lower element comprise snap fit elements such that the upper element and lower element may be coupled together by snap fitting.
Example Ex208. An aerosol-generating system according to Example Ex206 or Ex207, wherein at least an attachment section of the at least one attachment portions is located between the upper element and the lower element when the upper element and lower element are coupled together.
Example Ex209. An aerosol-generating system according to any of Examples Ex206 to Ex208, wherein at least an attachment section of the first electrical contact and at least a section of the second electrical contact is located between the upper element and the lower element when the upper element and lower element are coupled together.
Example Ex210. An aerosol-generating system according to any of Examples Ex162 to Ex 209, wherein the aperture has a cross sectional area between 1 millimetre squared and 1000 millimetres squared in the first plane.
Example Ex211. An aerosol-generating system according to Example Ex210, wherein the aperture has a cross sectional area between 2 millimetres squared and 200 millimetres squared in the first plane.
Example Ex212. An aerosol-generating system according to Example Ex211, wherein the aperture has a cross sectional area between 4 millimetres squared and 50 millimetres squared in the first plane.
Example Ex213. An aerosol-generating system according to any of Examples Ex162 to Ex 212, wherein the heating element further comprises at least one heat isolating portion, and wherein each attachment portion is separated from the frame by one heat isolating portion.
Example Ex214. An aerosol-generating system according to Example Ex213, wherein each heating portion is connected to the frame via at least one heat isolating portion.
Example Ex215. An aerosol-generating system according to Example Ex213 or Ex214, wherein the plurality of heating portions, the at least one attachment portions, and the at least one heat isolating portion are all integrally formed.
Example Ex216. An aerosol-generating system according to any of Examples Ex213 to Ex215 when dependent on Example Ex171, wherein each heat isolating portion has a third width in the first direction, and wherein the third width is smaller than the second width.
Example Ex217. An aerosol-generating system according to Example Ex216, wherein the ratio of the third width to the second width is between 1/10 and ⅔.
Example Ex218. An aerosol-generating system according to Example Ex217, wherein the ratio of the third width to the second width is between ⅕ and ⅓.
Example Ex219. An aerosol-generating system according any of Examples Ex216 to Ex218, wherein the third width is approximately equal to the first width.
Example Ex220. An aerosol-generating system according to any of Examples Ex213 to Ex219, wherein the thermal resistance over each attachment portion between adjacent heating portions and adjacent heat isolating portions is lower than the thermal resistance over each heat isolating portion between adjacent attachment portions and the frame.
Example Ex221. An aerosol-generating system according to any of Examples Ex162 to Ex 220, wherein each heating portion comprises a radius of curvature orthogonal to the first plane.
Example Ex222. An aerosol-generating system according to any of Examples Ex162 to Ex 221, wherein the heating element comprises a resilient material.
Example Ex223. An aerosol-generating system according to any of Examples Ex162 to Ex 222, wherein the frame comprises an upper surface parallel to the first plane, and at least a first part of the heating element is recessed from the upper surface of the frame by a first distance.
Example Ex224. An aerosol-generating system according to Example Ex223, wherein the first distance is between 0.2 mm and 5 mm.
Example Ex225. An aerosol-generating system according to Example Ex223 or Ex224, wherein an attachment section of the at least one attachment portions is recessed from the upper surface of the frame by the first distance.
Example Ex226. An aerosol-generating system according to any of Examples Ex223 to Ex225, wherein at least a second part of the heating element coincides with a plane formed by the upper surface of the frame.
Example Ex227. An aerosol-generating system according to any of Examples Ex223 to Ex225, wherein the entire heating element is recessed from the upper surface of the frame by the first distance.
Example Ex228. An aerosol-generating system according to any of Examples Ex223 to Ex227, wherein the frame comprises a lower surface parallel to the first plane, and at least the first part of the heating element is recessed from the lower surface of the frame by a second distance.
Example Ex229. An aerosol-generating system according to Example Ex228, wherein the second distance is between 0.2 mm and 5 mm.
Example Ex230. An aerosol-generating system according to Example Ex228 or Ex229, wherein an attachment section of the at least one attachment portions is recessed from the lower surface of the frame by the second distance.
Example Ex231. An aerosol-generating system according to any of Examples Ex162 to Ex 230, further comprising a support structure, wherein the frame at least partially surrounds the support structure, and wherein the support structure comprises a support structure aperture.
Example Ex232. An aerosol-generating system according to Example Ex231, wherein at least a portion of the heating element is within or overlies the support structure aperture.
Example Ex233. An aerosol-generating system according to Example Ex232, wherein the plurality of heating portions is within or overlies the support structure aperture.
Example Ex234. An aerosol-generating system according to any of Examples Ex231 to Ex233, wherein the support structure comprises an upper support structure surface parallel to the first plane, and at least a part of the heating element is co-planar with the upper support structure surface.
Example Ex235. An aerosol-generating system according to Example Ex234, wherein the plurality of heating portions are co-planar with the upper support structure surface.
Example Ex236. An aerosol-generating system according to Example Ex234 or Ex235, wherein each attachment portion comprises a first section and a second section, and wherein each first section is substantially coplanar with the upper support structure surface, and each second section extends from the upper support structure surface towards a second plane, the second plane being parallel but not co-planar with the upper support structure surface.
Example Ex237. An aerosol-generating system according to Example Ex236, wherein each second section extends in a direction perpendicular to the upper support structure surface.
Example Ex238. An aerosol-generating system according to Example Ex236 or Ex237, wherein each second section is positioned between the frame and the support structure.
Example Ex239. An aerosol-generating system according to any of Examples Ex234 to Ex238, wherein both of the first and second electrical contacts comprise a first electrical contact section and a second electrical contact section, and wherein both first electrical contact sections are substantially coplanar with the upper support structure surface, and both second electrical contact sections extend from the upper support structure surface towards the second plane.
Example Ex240. An aerosol-generating system according to Example Ex239, wherein both second electrical contact sections extend in a direction perpendicular to the upper support structure surface.
Example Ex241. An aerosol-generating system according to Example Ex239 or Ex240, wherein both second electrical contact sections are positioned between the frame and the support structure.
Example Ex242. An aerosol-generating system according to any of Examples Ex234 to Ex241, wherein the frame comprises an upper surface co-planar with the upper support structure surface.
Example Ex243. An aerosol-generating system according to any of Examples Ex234 to Ex242, wherein the frame comprises a lower frame surface and wherein the support structure comprises a lower support structure surface co-planar with the lower surface of the frame, wherein each of the first and second electrical contacts further comprise a third electrical contact section, and wherein both third electrical contact sections are substantially co-planar with the lower surface of the frame.
Example Ex244. An aerosol-generating system according to any of Examples Ex240 to Ex243, wherein the plurality of heating portions are co-planar with the upper surface of the frame.
Example Ex245. A cartridge for an aerosol-generating system, the cartridge comprising:
   an aerosol-forming substrate in fluid communication with a wicking material,
   and
   a heater assembly, the heater assembly comprising:
      a heating element, wherein the wicking material is in contact with the heating element,
      a first electrical contact in electrical contact with a first end of the heating element, and
      a second electrical contact in electrical contact with a second end of the heating element, the heating element providing a continuous electrical path between the first electrical contact and the second electrical contact;
      wherein the heating element comprises a plurality of heating portions and at least one attachment portion positioned between heating portions along the continuous electrical path,
      a frame comprising an aperture,
      wherein the heating element is fixed to the frame and wherein each heating portion is within or overlies the aperture and is separated from the frame by at least one attachment portion, and
      wherein the cross sectional area of each heating portion perpendicular to the direction of the continuous electrical path is less than the cross sectional area of each attachment portion perpendicular to the direction of the continuous electrical path.
Example Ex246. A cartridge according to Example Ex245, wherein the cartridge is configured to be reversibly couplable to and decouplable from an aerosol-generating device.
Example Ex247. A cartridge according to Example Ex245 or Ex246, further comprising a cartridge air flow passage defined between an cartridge air inlet and a cartridge air outlet.
Example Ex248. A cartridge according to Example Ex247, wherein the cartridge air outlet comprises a mouthpiece.
Example Ex249. A cartridge according to any of Examples Ex245 to Ex248, wherein the aerosol-forming substrate is a liquid at standard temperature and pressure.
Example Ex250. A cartridge according to any of Examples Ex245 to Ex249, wherein the plurality of heating portions and the at least one attachment portion are all integrally formed.
Example Ex251. A cartridge according to any of Examples Ex245 to Ex250, wherein each attachment portion is directly connected to exactly two heating portions.
Example Ex252. A cartridge according to any of Examples Ex245 to Ex251, wherein each heating portion is directly connected to exactly two attachment portions, or exactly one attachment portion and either the first electrical contact or the second electrical contact.
Example Ex253. A cartridge according to any of Examples Ex245 to Ex252, wherein each heating portion has a first width in a first direction, and each attachment portion has a second width in the first direction, and wherein the second width is greater than the first width.
Example Ex254. A cartridge according to Example Ex253, wherein the ratio of the first width to the second width is between 1/20 and ½.
Example Ex255. A cartridge according to Example Ex254, wherein the ratio of the first width to the second width is between 1/10 and ¼.
Example Ex256. A cartridge according to Example Ex253, Ex254 or Ex255, wherein the first width is between 0.1 millimetres and 2 millimetres.
Example Ex257. A cartridge according to Example Ex256, wherein the first width is between 0.2 millimetres and 1 millimetre.
Example Ex258. A cartridge according to Example Ex257, wherein the first width is between 0.2 millimetres and 0.5 millimetres.
Example Ex259. A cartridge according to any of Examples Ex245 to Ex258, wherein the heating element has a thickness in at least one direction perpendicular to the first direction.
Example Ex260. A cartridge according to Example Ex259, wherein the thickness is between 0.02 millimetres and 0.5 millimetres.
Example Ex261. A cartridge according to Example Ex260, wherein the thickness is between 0.05 millimetres and 0.3 millimetres.
Example Ex262. A cartridge according to any of Examples Ex245 to Ex261, wherein the electrical resistance per unit length in the direction of the electrically conductive path of the plurality of heating portions is greater than the electrical resistance per unit length in the direction of the electrically conductive path of the at least one attachment portions.
Example Ex263. A cartridge according to any of Examples Ex245 to Ex262, wherein the electrical resistance of each heating portion is higher than the electrical resistance of each attachment portion.
Example Ex264. A cartridge according to any of Examples Ex245 to Ex263, wherein the heater assembly is configured such that when a non-zero voltage is applied across the heating element between the first and second electrical contacts, the temperatures of the plurality of heating portions increase more than the temperatures of the at least one attachment portions.
Example Ex265. A cartridge according to any of Examples Ex245 to Ex264, wherein the heating element is serpentine in shape.
Example Ex266. A cartridge according to any of Examples Ex245 to Ex265, wherein the heating element comprises stainless steel.
Example Ex267. A cartridge according to any of Examples Ex245 to Ex266, wherein the heating element comprises a ferrimagnetic or ferromagnetic material.
Example Ex268. A cartridge according to any of Examples Ex245 to Ex267, wherein the heating element is coated with a corrosion resistant material.
Example Ex269. A cartridge according to any of Examples Ex245 to Ex268, wherein the heating element is coated with a ceramic material.
Example Ex270. A cartridge according to any of Examples Ex245 to Ex269, wherein the heating element is substantially flat.
Example Ex271. A cartridge according to any of Examples Ex245 to Ex270, wherein the total resistance of the heating element is between 0.1 Ohms and 5 Ohms.
Example Ex272. A cartridge according to Example Ex271, wherein the total resistance of the heating element is between 0.2 Ohms and 1.5 Ohms.
Example Ex273. A cartridge according to any of Examples Ex245 to Ex272, wherein the heating element and the first and second electrical contacts are integrally formed.
Example Ex274. A cartridge according to any of Examples Ex245 to Ex273, wherein the heating element and the first and second electrical contacts are formed of the same material.
Example Ex275. A cartridge according to any of Examples Ex245 to Ex274, wherein the aperture is substantially square or rectangular.
Example Ex276. A cartridge according to any of Examples Ex245 to Ex274, wherein the aperture is substantially circular.
Example Ex277. A cartridge according to any of Examples Ex245 to Ex276, wherein the frame is electrically insulating.
Example Ex278. A cartridge according to Example Ex277, wherein the frame has a thermal conductivity of 1 W/mK or less.
Example Ex279. A cartridge according to Example Ex277 or Ex278, wherein the frame comprises a heat-resistant polymer.
Example Ex280. A cartridge according to any of Examples Ex277 to Ex279, wherein the frame comprises polyether ether ketone (PEEK).
Example Ex281. A cartridge according to Example Ex277 or Ex278, wherein the frame comprises a ceramic.
Example Ex282. A cartridge according to Example Ex281, wherein the frame comprises alumina.
Example Ex283. A cartridge according to Example Ex281, wherein the frame comprises zirconia.
Example Ex284. A cartridge according to any of Examples Ex245 to Ex283, wherein the frame is overmoulded over a section of the heating element.
Example Ex285. A cartridge according to Example Ex284, wherein the frame is overmoulded over an attachment section of the at least one attachment portions.
Example Ex286. A cartridge according to any of Examples Ex245 to Ex285, wherein the frame is overmoulded over at least an attachment section of the first electrical contact and at least a section of the second electrical contact.
Example Ex287. A cartridge according to any of Examples Ex245 to Ex283, wherein the frame comprises an upper element and a lower element.
Example Ex288. A cartridge according to Example Ex287, wherein the upper element and the lower element comprise press fit elements such that the upper element and the lower elements may be coupled together by press fitting.
Example Ex289. A cartridge according to Example Ex287, wherein the upper element and the lower element comprise snap fit elements such that the upper element and lower element may be coupled together by snap fitting.
Example Ex290. A cartridge according to Example Ex288 or Ex289, wherein at least an attachment section of the at least one attachment portions is located between the upper element and the lower element when the upper element and lower element are coupled together.
Example Ex291. A cartridge according to any of Examples Ex288 to Ex290, wherein at least an attachment section of the first electrical contact and at least a section of the second electrical contact is located between the upper element and the lower element when the upper element and lower element are coupled together.
Example Ex292. A cartridge according to any of Examples Ex245 to Ex291, wherein the aperture has a cross sectional area between 1 millimetre squared and 1000 millimetres squared in the first plane.
Example Ex293. A cartridge according to Example Ex292, wherein the aperture has a cross sectional area between 9 millimetres squared and 400 millimetres squared in the first plane.
Example Ex294. A cartridge according to Example Ex293, wherein the aperture has a cross sectional area between 16 millimetres squared and 100 millimetres squared in the first plane.
Example Ex295. A cartridge according to any of Examples Ex245 to Ex294, wherein the heating element further comprises at least one heat isolating portion, and wherein each attachment portion is separated from the frame by one heat isolating portion.
Example Ex296. A cartridge according to Example Ex295, wherein each heating portion is connected to the frame via at least one heat isolating portion.
Example Ex297. A cartridge according to Example Ex295 or Ex296, wherein the plurality of heating portions, the at least one attachment portions, and the at least one heat isolating portion are all integrally formed.
Example Ex298. A cartridge according to any of Examples Ex295 to Ex297 when dependent on Example Ex253, wherein each heat isolating portion has a third width in the first direction, and wherein the third width is smaller than the second width.
Example Ex299. A cartridge according to Example Ex298, wherein the ratio of the third width to the second width is between 1/10 and ⅔.
Example Ex300. A cartridge according to Example Ex299, wherein the ratio of the third width to the second width is between ⅕ and ⅓.
Example Ex301. A cartridge according any of Examples Ex298 to Ex300, wherein the third width is approximately equal to the first width.
Example Ex302. A cartridge according to any of Examples Ex295 to Ex301, wherein the thermal resistance over each attachment portion between adjacent heating portions and adjacent heat isolating portions is lower than the thermal resistance over each heat isolating portion between adjacent attachment portions and the frame.
Example Ex303. A cartridge according to any of Examples Ex245 to Ex302, wherein each heating portion comprises a radius of curvature orthogonal to the first plane.
Example Ex304. A cartridge according to any of Examples Ex245 to Ex303, wherein the heating element comprises a resilient material.
Example Ex305. A cartridge according to any of Examples Ex245 to Ex304, wherein the frame comprises an upper surface parallel to the first plane, and at least a first part of the heating element is recessed from the upper surface of the frame by a first distance.
Example Ex306. A cartridge according to Example Ex305, wherein the first distance is between 0.2 mm and 5 mm.
Example Ex307. A cartridge according to Example Ex305 or Ex306, wherein an attachment section of the at least one attachment portions is recessed from the upper surface of the frame by the first distance.
Example Ex308. A cartridge according to any of Examples Ex305 to Ex307, wherein at least a second part of the heating element coincides with a plane formed by the upper surface of the frame.
Example Ex309. A cartridge according to any of Examples Ex305 to Ex307, wherein the entire heating element is recessed from the upper surface of the frame by the first distance.
Example Ex310. A cartridge according to any of Examples Ex305 to Ex309, wherein the frame comprises a lower surface parallel to the first plane, and at least the first part of the heating element is recessed from the lower surface of the frame by a second distance.
Example Ex311. A cartridge according to Example Ex310, wherein the second distance is between 0.2 mm and 5 mm.
Example Ex312. A cartridge according to Example Ex310 or Ex311, wherein an attachment section of the at least one attachment portions is recessed from the lower surface of the frame by the second distance.
Example Ex313. A cartridge according to any of Examples Ex245 to Ex312, further comprising a support structure, wherein the frame at least partially surrounds the support structure, and wherein the support structure comprises a support structure aperture.
Example Ex314. A cartridge according to Example Ex313, wherein at least a portion of the heating element is within or overlies the support structure aperture.
Example Ex315. A cartridge according to Example Ex314, wherein the plurality of heating portions is within or overlies the support structure aperture.
Example Ex316. A cartridge according to any of Examples Ex313 to Ex315, wherein the support structure comprises an upper support structure surface parallel to the first plane, and at least a part of the heating element is co-planar with the upper support structure surface.
Example Ex317. A cartridge according to Example Ex316, wherein the plurality of heating portions are co-planar with the upper support structure surface.
Example Ex318. A cartridge according to Example Ex316 or Ex317, wherein each attachment portion comprises a first section and a second section, and wherein each first section is substantially coplanar with the upper support structure surface, and each second section extends from the upper support structure surface towards a second plane, the second plane being parallel but not co-planar with the upper support structure surface.
Example Ex319. A cartridge according to Example Ex318, wherein each second section extends in a direction perpendicular to the upper support structure surface.
Example Ex320. A cartridge according to Example Ex318 or Ex319, wherein each second section is positioned between the frame and the support structure.
Example Ex321. A cartridge according to any of Examples Ex316 to Ex320, wherein both of the first and second electrical contacts comprise a first electrical contact section and a second electrical contact section, and wherein both first electrical contact sections are substantially coplanar with the upper support structure surface, and both second electrical contact sections extend from the upper support structure surface towards the second plane.
Example Ex322. A cartridge according to Example Ex321, wherein both second electrical contact sections extend in a direction perpendicular to the upper support structure surface.
Example Ex323. A cartridge according to Example Ex321 or Ex322, wherein both second electrical contact sections are positioned between the frame and the support structure.
Example Ex324. A cartridge according to any of Examples Ex316 to Ex323, wherein the frame comprises an upper surface co-planar with the upper support structure surface.
Example Ex325. A cartridge according to any of Examples Ex316 to Ex324, wherein the frame comprises a lower frame surface and wherein the support structure comprises a lower support structure surface co-planar with the lower surface of the frame, wherein each of the first and second electrical contacts further comprise a third electrical contact section, and wherein both third electrical contact sections are substantially co-planar with the lower surface of the frame.
Example Ex326. A cartridge according to any of Examples Ex324 to Ex325, wherein the plurality of heating portions are co-planar with the upper surface of the frame.

Features of one aspect or embodiment of the invention may be applied to the other aspects or embodiments of the invention.

Examples will now be further described with reference to the figures in which:

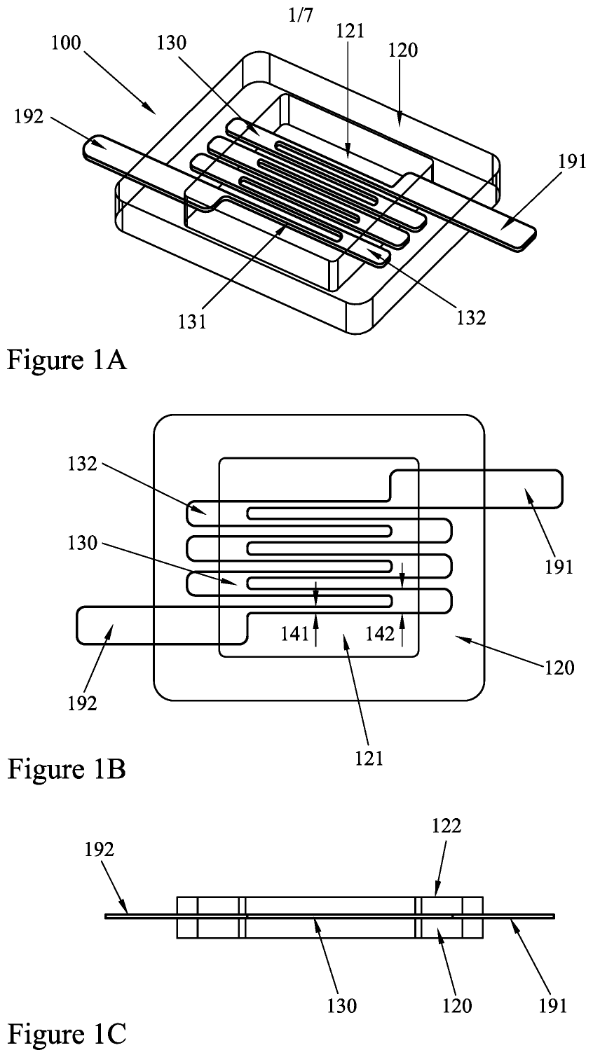

FIG. 1A shows a perspective view of a heater assembly;

FIG. 1B shows a plan view of the heater assembly of FIG. 1A;

FIG. 1C shows a side view of the heater assembly of FIG. 1A;

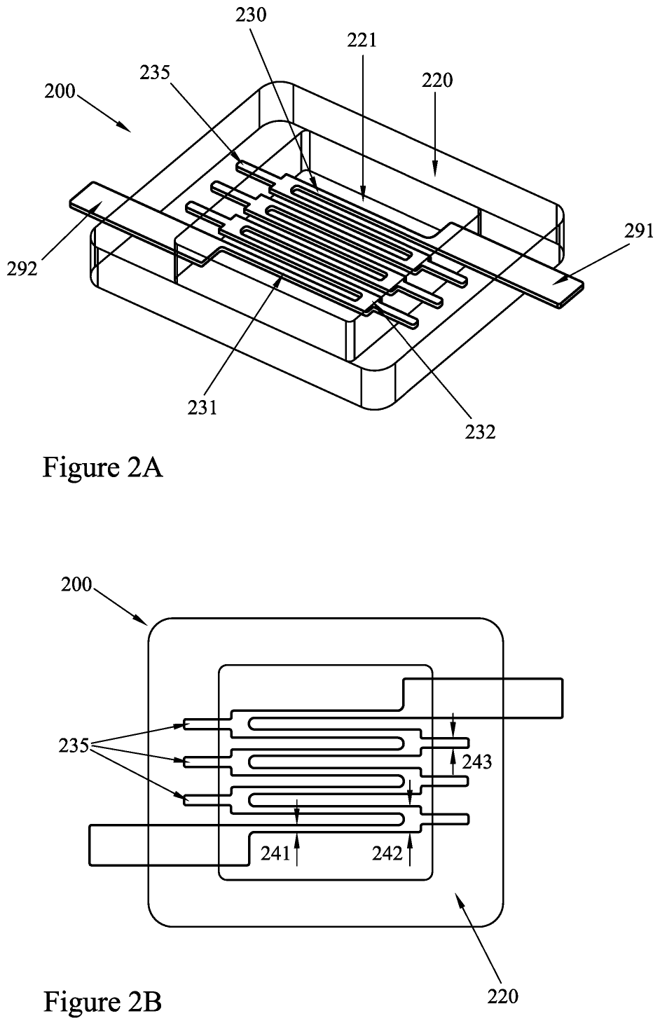

FIG. 2A shows a perspective view of another heater assembly;

FIG. 2B shows a plan view of the heater assembly of FIG. 2A;

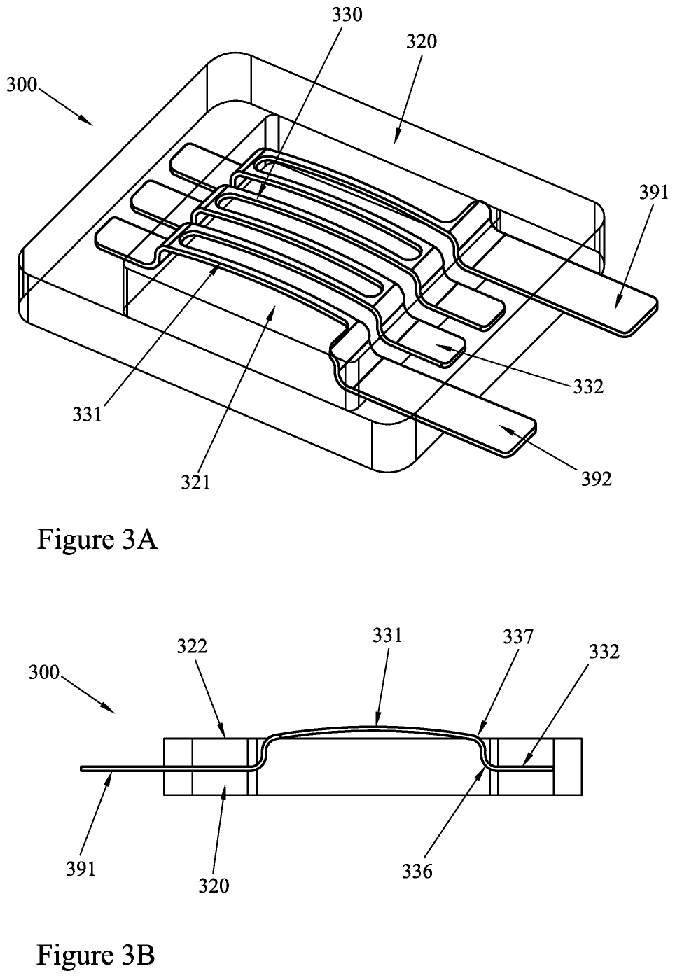

FIG. 3A shows a perspective view of a further heater assembly;

FIG. 3B shows a side view of the heater assembly of FIG. 3A;

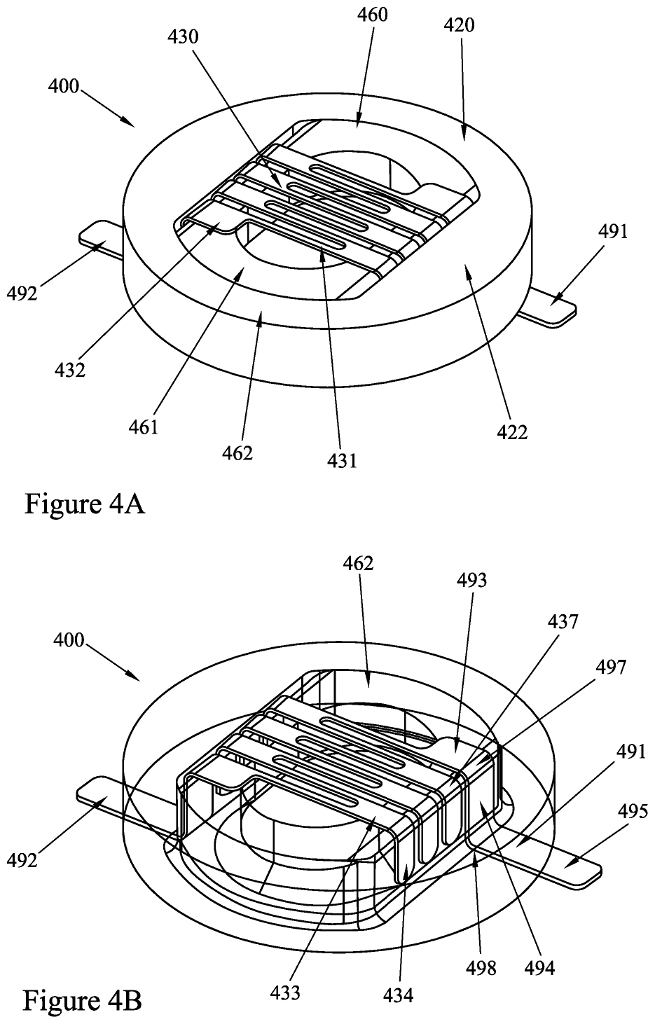

FIG. 4A shows a perspective view of a still further heater assembly;

FIG. 4B shows a perspective view of the heater assembly of FIG. 4A, with selected components of the heater assembly shown as transparent;

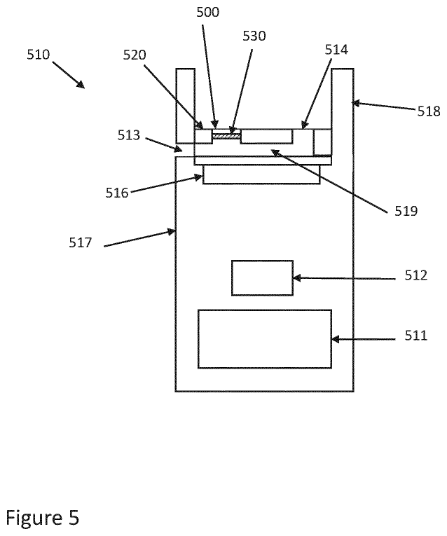

FIG. 5 shows a schematic of a cross-section of an aerosol-generating device, the aerosol-generating device comprising a heater assembly as shown in any of FIGS. 1A to 4B;

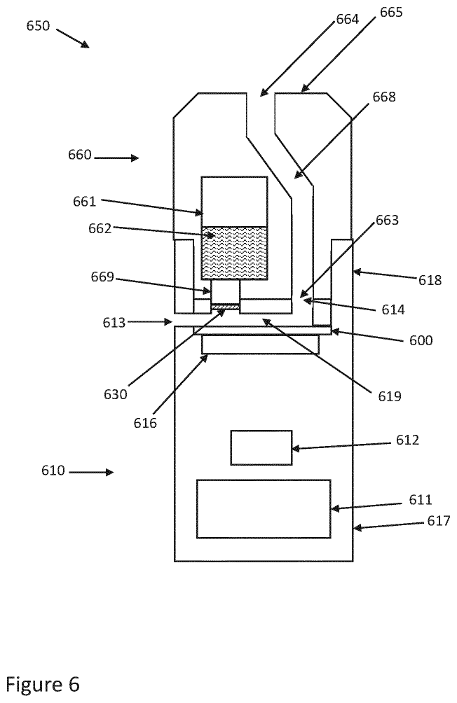

FIG. 6 shows a schematic of a cross-section of an aerosol-generating system, the aerosol-generating system comprising an aerosol-generating device as shown in FIG. 5, and a cartridge coupled to the aerosol-generating device; and

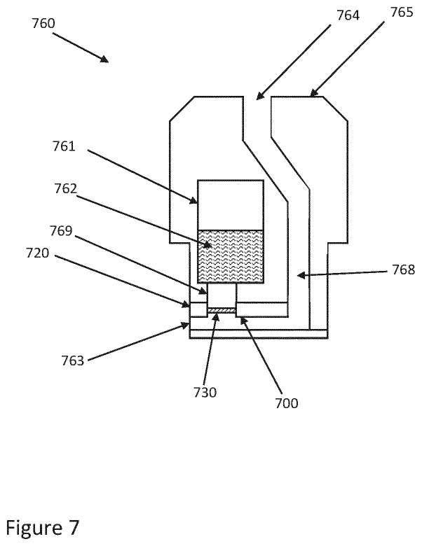

FIG. 7 shows a schematic of a cross-section of a cartridge according to yet another embodiment, the cartridge comprising a heater assembly as shown in any of FIGS. 1A to 4B.

FIG. 1A shows a perspective view of a heater assembly 100. The heater assembly 100 is for an aerosol-generating system, such as an electrically operated smoking system, often referred to as an e-cigarette system. The aerosol-generating system may be a handheld, portable system and has a size comparable to a conventional cigar or cigarette.

The heater assembly 100 comprises a frame 120. The frame 120 has a length and a width in a first plane and a height perpendicular to the first plane, the length and the width being greater than the height. The frame 120 therefore has an upper surface which extends in the first plane. The frame 120 is approximately square shaped in the first plane. The corners of frame 120 in the first plane are radiused. The frame 120 comprises an aperture 121, the aperture 121 located centrally in the frame 120. The aperture 121 passes through the frame perpendicular to the first plane. The aperture 121 is approximately square shaped parallel to the first plane. In this embodiment, the aperture 121 is the same shape as the frame 120, but this may not always be the case. The area of the aperture is 100 millimetres². For example, an approximately squared shape frame may comprise an approximately circular aperture. In the embodiment shown in FIG. 1A, the frame is formed from a heat resistant polymer, such as PEEK, though other suitable materials may be used instead.

The heater assembly 100 further comprises heating element 130. In the embodiment shown in FIG. 1A the heating element 130 is parallel to the first plane. Heating element 130 comprises a plurality of heating portions 131, and at least one attachment portion 132. In the embodiment shown in FIG. 1A, the heating element 130 comprises seven heating portions 131, and six attachment portions 132. In the embodiment shown in FIG. 1A, the plurality of heating portions 131 and at least one attachment portions 132 are integrally formed, and comprise a stainless steel.

The heater assembly 100 further comprises a first electrical contact 191 and a second electrical contact 192. The first electrical contact 191 is attached to a first end of the heating element 130. The second electrical contact 192 is attached to a second end of the heating element 130. The heating element 130 forms a serpentine continuous electrical path between the first electrical contact 191 and the second electrical contact 192. This continuous electrical path has a total electrical resistance of approximately 1 Ohm. A part of the heating element 130 overlies the aperture 121. In particular, each of the heating portions 131 and sections of the attachment portions 132 overlie the aperture 121. A part of the first electrical contact 191 and the second electrical contact 192 protrude out of opposite sides of the frame 120 to allow for electrical connections to external electronics.

The attachment portions 132 are each attached to the frame 120. In particular in this embodiment, the frame 120 is overmoulded over an attachment section of the attachment portions 132. The first electrical contact 191 and the second electrical contact 192 are also attached to the frame 120. In particular in this embodiment, the frame 120 is overmoulded over attachment sections of the first electrical contact 191 and the second electrical contact 192. Overmoulding the frame over attachment sections may however be replaced in alternative embodiments by either snap-fitting, press-fitting or fastening two frame elements together.

The heating element 130 and first and second electrical contacts 191, 192 are integrally formed, and are cut from a flat sheet of metal, for example by laser cutting, waterjet cutting or chemical etching.

In this first embodiment, the heating element 130 is uncoated, however the heating element 130 may be coated by a thin layer of a corrosion resistant material to increase the life span of the heating element 130. An example of such material is a ceramic material.

FIG. 1B shows a plan view of the heater assembly 100 according to the embodiment of FIG. 1A. The heating portions 131 are shown to have a first width 141 in a first direction, and the attachment portions are shown to have a second width 142, also in the first direction. The second width is greater than the first width. The first width is approximately 0.5 millimetres. The second width is approximately 1.5 millimetres. Therefore the ratio of the first width to the second with is approximately ⅓. The serpentine shape of the heating element 130 is more clearly seen in this plan view. The heating portions 131 are shown to have a constant width equal to the first width in the first direction along their entire length. The attachment portions 131 are also shown to have a constant width equal to the second width in the first direction along their entire length.

FIG. 1C shows a side view of the heater assembly 100 according to the embodiment of FIGS. 1A and 1B. The side view is in the first plane. The heating element 130 can be seen to be approximately planar in the first plane, in that the heating element 130 extends much further in the first plane than perpendicular to the first plane. The heating element 130 is shown to have an even thickness perpendicular to the first plane. The thickness of the heating element is approximately 0.1 millimetres. Therefore the heating portions 131 and the attachment portions 132 have an approximately equal thickness perpendicular to the first plane. The heating element 130 is recessed from an upper surface 122 of the frame 120. The heating element 130 is recessed from the upper surface 122 of the frame 120 by approximately 2 millimetres. Similarly, of the first and second electrical contacts 191, 192 are recessed from the upper surface 122 of the frame 120 by approximately 2 millimetres. Similarly, the heating element 130 and the first and second electrical contacts are recessed from a lower surface of the frame 120.

The heater assembly 100 is configured to be coupled to a wicking element, such that the wicking element is in direct contact with one side of the heating element 130. The other side of the heating element 130 may then be exposed to air.

When a current is passed through the heating element 130, or when a non-zero voltage is applied between the first electrical contact 191 and the second electrical contact 192, the heating element 130 heats up as a result of resistive heating. The current passes through the continuous electrical path formed by the heating element 130 in a serpentine direction defined by the shape of the heating element 130. Because the first width is greater than the second width, and the heating portions 131 and the attachment portions 132 have approximately equal thickness perpendicular to the first plane, the cross sectional area of each heating portion 131 perpendicular to the direction of the continuous electrical path is less than the cross sectional area of each attachment portion 132 perpendicular to the direction of the continuous electrical path. Therefore, when a current is passed through heating element 130, or when a non-zero voltage is applied between the first electrical contact 191 and the second electrical contact 192, the temperature of the heating portions 131 will increase more than the temperature of the attachment portions 132.

The effect of the temperature of the heating portions 131 increasing more than the temperature of the attachment portions 132 may be achieved in alternative way. For example, the thicknesses of the heating portions and the attachment portions may be different.

FIG. 2A shows a perspective view of a heater assembly 200 according to another embodiment. The frame 220 and aperture 221 are identical to that shown in FIGS. 1A-1C. The heater assembly 200 comprises a heating element 230, the heating element 230 comprising a plurality of heating portions 231 and at least one attachment portion 232, as in the first embodiment. The heater assembly 200 also comprises a first electrical contact 291 and a second electrical contact 292, as in the first embodiment. Where this embodiment differs from the embodiment of FIG. 1A is that the heating element 230 further comprises at least one heat isolating portion 235. In the embodiment shown in FIG. 2A, The heating element 230 comprises six heat isolating portions 235. The number of heat isolating portions 235 is equal to the number of attachment portions 232. Each one of the heat isolating potions 235 are connected between the frame 220 and one of the attachment portions 232. In particular in the second embodiment, the frame 120 is overmoulded Over a section of each of the heat isolating portions 235. Therefore, each attachment portion 232 is separated from the frame by one heat isolating portion 235. In the embodiment shown in FIG. 2A, the plurality of heating portions 231, at least one attachment portions 232 and at least one heat isolating portions 235 are integrally formed, and comprise a stainless steel. The plurality of heating portions 231, at least one attachment portions 232 and at least one heat isolating portions 235 have approximately equal thickness perpendicular to the first plane.

FIG. 2B shows a plan view of a heater assembly of FIG. 2A. As in the embodiment of FIG. 1A, the heating portions 231 are shown to have a first width 241 in a first direction, and the attachment portions are shown to have a second width 242, also in the first direction. The second width is greater than the first width. In this second embodiment, the heat isolating potions 235 have a third width in the first direction. The second width is greater than the third width. The third width is approximately 0.75 millimetres. The ratio of the third width to the second width is therefore approximately ½. In the embodiment shown, the third width is greater than the first width, though this may not always be the case. For example, the third width may be approximately equal to the first width, or less than the first width. The thickness of the plurality of heating portions 231, the at least one attachment portions 232 and the at least one heat isolating portions 235

When a current is passed through heating element 230, or when a non-zero voltage is applied between the first electrical contact 291 and the second electrical contact 292, the heating portions 231 and attachment portions 232 heat up as a result of resistive heating. Although the temperature of attachment portions 232 increases less than the temperature of the heating portions 231, as described with respect to FIGS. 1A-1C, the attachment portions 232 may reach a temperature wherein direct contact between attachment portions 232 and the frame 220 is undesirable. Because the third width of heat isolating portions 235 is less than the second width of attachment portions 232, the amount of energy transferred from attachment portions to the frame 220 when a current is passed through the heating element 230 is less than if the attachment portions 232 were instead attached to the frame 220, as in the first embodiment for example. FIG. 3A shows a perspective view of a heater assembly according to a further embodiment. The frame 320 and aperture 321 are identical to that shown in FIGS. 1A-1C and 2A-2B. The heater assembly 300 comprises a heating element 330, the heating element 330 comprising a plurality of heating portions 331 and at least one attachment portion 332, as in the first and second embodiments. The heater assembly 300 also comprises a first electrical contact 391 and a second electrical contact 392, as in the embodiments of FIGS. 1A-C and FIGS. 2A and 2B. Where this further embodiment differs from the embodiment of FIG. 1A is in the shape of the heating element 330, which can also be seen in FIG. 3B.

FIG. 3B shows a side view of a heater assembly according to the further embodiment. The plurality of heating portions 331 each comprise a radius of curvature orthogonal to the first plane. The outer surface of the curved heating portions 331 is configured to be coupled to a wicking element.

Attachment sections of attachment portions 332, and sections of the first and second electrical contacts 391, 392 are recessed from an upper surface 322 of the frame 320 by approximately 2 millimetres. Similarly, attachment sections of the attachment portions 332, and sections of the first and second electrical contacts 391, 392 are recessed from a lower surface of the frame 320. The attachment portions 332 and the first and second electrical contacts 391, 392 comprise two sets of approximately ninety degree bends. The first set of approximately ninety degree bends 336 orient the attachment portions 332 and the first and second electrical contacts 391, 392 such that they extend perpendicular to the first plane. The second set of approximately ninety degree bends 337 orient the attachment portions 332 and the first and second electrical contacts 391, 392 away from the perpendicular to the first plane. The two sets of approximately ninety degree bends are therefore arranged such that the plurality of heating portions 331 intersect the upper surface 322 of the frame 320, and at least a part of each heating portion 331 extends beyond the plane formed by the upper surface 322 of the frame 320. In this further embodiment, the heating element is bent by cold stamping or micro-bending.

FIG. 4A shows a perspective view of a heater assembly according to a still further embodiment. The heater assembly 400 comprises a heating element 430, the heating element 430 comprising a plurality of heating portions 431 and at least one attachment portion 432, as in the earlier described embodiments. The heater assembly 400 also comprises a first electrical contact 491 and a second electrical contact 492, as in the earlier described embodiments. In contrast to the first embodiment, in this still further embodiment the heater assembly 400 further comprises a support structure 460. The frame 420 surrounds the support structure 460 in the first plane. The support structure 460 can be considered to be located within the aperture of the frame 420. The frame 420 comprises a circular perimeter, and an approximately oval shaped aperture.

The support structure 460 comprises an approximately oval shaped perimeter, the perimeter being the same size and shape of the approximately oval shaped aperture of the frame, such that gaps between the frame 420 and the support structure 460 are minimal. The support structure 460 comprises an approximately oval shaped support structure aperture 461 in the first plane. The support structure 460 comprises an upper support structure surface 462 parallel to the first plane, and co-planar with the upper surface 422 of the frame 420. The plurality of heating portions 431 are co-planar with the upper support structure surface 462, and overlie the support structure aperture 461.

FIG. 4B shows a perspective view of a heater assembly of FIG. 4A, with selected components of the heater assembly shown as transparent. In particular, the frame 420 and the support structure 460 are shown as transparent. Each attachment portion 432 comprises a first section 433 and a second section 434. Each first section 433 lies upon the upper support structure surface 462, and so may be considered as co-planar with the upper support structure surface 462. Each attachment portion 432 further comprises a first set of approximately ninety degree bends 437. This first set of ninety degree bends orients each second section 434 such that each second section 434 extends from the upper support structure surface 462 perpendicular to the upper support structure surface 462. Each second section 434 is therefore positioned between the frame 420 and the support structure 460.

Additionally, both of the first and second electrical contacts 491, 492 comprise a first electrical contact section 493, a second electrical contact section 494 and a third electrical contact section 495. In a similar fashion to that of the attachment portions 432, both of the first electrical contact sections 493 are substantially co-planar with the upper support structure surface 462. Both of the first and second electrical contacts 491, 492 further comprise two approximately ninety degree bends 497, 496. The first pair of ninety degree bends 497 orients both second electrical contact sections 494 such that both second electrical contact sections 494 extend from the upper support structure surface 462 perpendicular to the upper support structure surface 462. Both second electrical contact sections 494 are therefore positioned between the frame 420 and the support structure 460. The second pair of ninety degree bends 498 orients the third electrical contact sections 495 such that the third electrical contact sections 495 are co-planar with the lower surface of the frame, and parallel to the first plane. In this embodiment, the heating element is bent by cold stamping or micro-bending.

FIG. 5 shows a schematic of a cross-section of an aerosol-generating device 510, the aerosol-generating device comprising a heater assembly 500 according to any of the previously described embodiments.

The aerosol-generating device 510 is an electrically operated smoking device, often referred to as an e-cigarette system. The aerosol-generating device 510 is a handheld, portable device and has a size comparable to a conventional cigar or cigarette.

The device 510 comprises a battery 511, such as a lithium iron phosphate battery, and a controller 512 electrically connected to the battery 511.

The device 510 comprises an outer casing 517. The outer casing contains the battery 511 and the controller 512. The device 510 is configured to be coupled to a cartridge comprising a wicking element and an aerosol-forming substrate. The device 510 comprises a cartridge coupling portion 518 extending from a proximal end of the device 510. The cartridge coupling portion 518 extends from the outer casing 517 annularly, and provides a cavity into which a cartridge may be accepted.

The heater assembly 500 comprises a fluid permeable heating element 530 and a frame 520, both as described in previous embodiments. First and second electrical contacts (not shown) are electrically connected with the heating element 530, the battery 511 and the controller 512.

The device 510 comprises a device air inlet 513 and a device air outlet 514. The device air inlet 513 is defined in a side wall of the device 610. The device air outlet is defined in a proximal end of the device. The device 510 comprises a device airflow passage 519. The device airflow passage 519 is defined between the device air inlet 513 and the device air outlet 514. The heating element 530 is positioned downstream of the device air inlet 513 and upstream of the device air outlet 514, and is in fluid communication with the device airflow passage 519. In particular, a lower side of the heating element 530 is in fluidic communication with the device airflow passage 519. It can be see that the device airflow passage 519 comprises a heater assembly airflow passage. The heater assembly airflow passage is defined between a heater assembly air inlet and a heater assembly air outlet. In the embodiment shown, the device air outlet 514 comprises the heater assembly air outlet.

The device 510 further comprises a spring element 516. Spring element 516 is fixed relative to the outer casing 517, and is in contact with the heater assembly 500.

FIG. 6 shows a schematic of a cross-section of an aerosol-generating system, the aerosol-generating system comprising an aerosol-generating device as described with reference to FIG. 5 and a cartridge coupled to the aerosol-generating device

The cartridge 660 is coupled to the device 610 by the cartridge coupling portion 618. The cartridge 660 comprises a liquid aerosol-forming substrate 662 in a reservoir 661, and a ceramic wicking element 669. In this system, the reservoir 661 is in fluid communication with the ceramic wicking element 669, so that liquid aerosol-forming substrate 662 can flow from the reservoir 661 to the wicking element 669. The wicking element 669 comprises a capillary material having a fibrous or spongy structure. The wicking element 669 also forms part of the external surface of the cartridge 660.

The device air outlet 614 is configured to align with a cartridge air inlet 663 when the device 610 is coupled to the cartridge 660. When the device 610 is coupled to the cartridge 660 the device air flow passage 619 is connected to a cartridge air flow passage 668, defining a system air flow passage from the device air inlet 613 to the cartridge air outlet 664. The cartridge comprises a mouthpiece 665, and the cartridge air outlet 664 is defined in the mouthpiece 665.

The wicking element 669 is configured to align with an aperture of the frame of the heater assembly. In this particular embodiment, when the system comprises a heater assembly according to the first embodiment, the aperture is approximately square shaped with a cross-sectional area of approximately 100 millimetre². The wicking element 669 also has an approximately square cross-section with an approximately identical cross sectional area, so that the wicking element 669 may be easily received by the aperture of the frame of the heater assembly. When the cartridge 660 is coupled to the device 610, a distal end of the wicking element contacts an upper side of the heating element 630.

The device 610 further comprises a spring element 616. Spring element 616 is fixed relative to the device outer casing 617, and is in contact with the heater assembly 600. When a user couples the cartridge 650 to the device 610, the spring element 617 exerts a force of the heater assembly 600. The force exerted onto the heater assembly 600 ensures that good contact is made between the upper side of the heating element 630 and the wicking element 669.

In use, a user puffs on the mouthpiece of the cartridge 665 drawing air into the device air inlet 613. The system 650 is puff actuated meaning that a puff sensor (not shown), which may be a pressure sensor or an air flow sensor, is located in the system 650. In particular, the puff sensor will be located in fluid communication with the system airflow passage, and preferably within or adjacent to the device airflow passage 619. The puff sensor will detect the user puff and send a signal to the controller 612, which results in power being supplied from the battery 611 to the heating element 630 of the heater assembly, via the first and second electrical contacts. This causes a current to flow through the heating element 630, thereby resistively heating the heating element 630. In other examples, the aerosol-generating system 650 may comprise a button that a user presses to send a signal to the controller 612 to supply power from the battery 611 to the heating element 630.

As the heating element 630 is heated, it heats the wicking element 669 and therefore any aerosol-forming substrate 662 contained in the wicking element 669. The heating of the wicking element 669 causes the aerosol-forming substrate 662 to be vaporised.

As the user puffs on the cartridge air outlet 664, air is drawn into the device air inlet 613. The air will pass across the heater assembly as it is drawn through the air passage. The air will flow across a lower side of heating element 630, across the surface of the wicking element 669 and towards the cartridge air outlet 664. The vaporised aerosol-forming substrate 662 is entrained in this flowing air. This entrained vapour then cools and condenses to form an aerosol. The aerosol leaves the device air flow passage 619 through the air outlet 614. Then the aerosol enters the cartridge 660 through the cartridge air inlet 663, exits the cartridge 660 through the cartridge air outlet 664, and is delivered to the user's mouth.

As liquid aerosol-forming substrate 662 in the wicking element 669 is heated, vaporised, and entrained in the air flow, liquid aerosol-forming substrate 662 from the reservoir 661 travels into the wicking element 669. This aerosol-forming substrate 662 from the reservoir 661 effectively replaces the vaporised aerosol-forming substrate 662. Because the wicking element 669 is a capillary material having a fibrous or spongy structure, the liquid aerosol-forming substrate 662 from the reservoir 661 may be drawn into the wicking element 669, at least partly, by capillary action.

After many uses of the aerosol-generating system 650, the wicking element 669 may start to degrade or the reservoir 661 may become empty of aerosol-forming substrate 662. The user can then uncouple the cartridge 660 from the device 610. The cartridge 660 can be removed and disposed of. The aerosol-generating device 610 can then be re-used with a new cartridge.

FIG. 7 shows a schematic of a cross-section of a cartridge 760 according to another embodiment, the cartridge 760 comprising a heater assembly 700 according to any of the embodiments described with reference to FIGS. 1A to 4B.

Similarly to the cartridge 660 shown in FIG. 6, the cartridge 760 shown in FIG. 7 comprises a liquid aerosol-forming substrate 762 in a reservoir 761, and a ceramic wicking element 769. In this system, the reservoir 761 is in fluid communication with the ceramic wicking element 769, so that liquid aerosol-forming substrate 662 can flow from the reservoir 661 to the wicking element 669. The cartridge further comprises a mouthpiece 765, and the cartridge air outlet 764 is defined in the mouthpiece 765.

In contrast to the embodiment shown in FIGS. 5 and 6, the heater assembly 700 is located in the cartridge 760, rather than an aerosol-generating device. The heater assembly 700 is located such that the wicking element 769 is aligned with the aperture of the frame of the heater assembly 700, and such that the distal end of the wicking element 769 contacts the upper side of the heating element 730. Additionally, the cartridge comprises a cartridge air inlet 763 upstream of the heater assembly 700, such that a cartridge air flow path 768 is defined between the cartridge air inlet 763 and the cartridge air outlet 764, and the heating element 730 is in fluid communication with the cartridge air flow path 768.

The cartridge 760 is configured to be coupled to a suitable aerosol-generating device, the device comprising a battery, such as a lithium iron phosphate battery, a controller electrically connected to the battery, first and second device electrical contact portions, and a cartridge coupling portion providing a cavity into which a cartridge 760 may be accepted.

The cartridge 760 comprises first and second cartridge electrical contact portions (not shown), configured to contact first and second device electrical contact portions when the cartridge 760 is coupled to the suitable device, such that power may be supplied from a battery to the heating element 730.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. A heater assembly for an aerosol-generating device, the heater assembly comprising:
a heating element;
a first electrical contact in electrical contact with a first end of the heating element;
a second electrical contact in electrical contact with a second end of the heating element, the heating element providing a continuous electrical path between the first electrical contact and the second electrical contact; and
a frame comprising an aperture in a first plane,
wherein the heating element comprises a plurality of heating portions and at least one attachment portion positioned between heating portions along the continuous electrical path,
wherein the heating element is fixed to the frame and wherein each heating portion is within or overlies the aperture and is separated from the frame by at least one attachment portion,
wherein a cross-sectional area of each heating portion perpendicular to a direction of the continuous electrical path is less than a cross-sectional area of each attachment portion perpendicular to the direction of the continuous electrical path,
wherein the heating element further comprises at least one heat-isolating portion,
wherein each attachment portion is separated from the frame by one heat-isolating portion, and
wherein the plurality of heating portions, the at least one attachment portions, and the at least one heat-isolating portion are all integrally formed.

16. The heater assembly according to claim 15, wherein the plurality of heating portions and the at least one attachment portion are all integrally formed.

17. The heater assembly according to claim 15,
wherein each heating portion has a first width in a first direction perpendicular to the direction of the continuous electrical path when the direction of the continuous electrical path is defined by each heating portion, and each attachment portion has a second width in the first direction, and
wherein the second width is greater than the first width.

18. The heater assembly according to claim 15,
wherein each heat-isolating portion has a third width in the first direction, and
wherein the third width is smaller than the second width.

19. The heater assembly according to claim 15, wherein the heating element is substantially flat.

20. The heater assembly according to claim 15, wherein the frame is overmoulded over a section of the heating element.

21. The heater assembly according to claim 15, wherein the frame further comprises an upper element and a lower element.

22. The heater assembly according to claim 15, wherein the frame is electrically insulating.

23. The heater assembly according to claim 22, wherein the frame has a thermal conductivity of 1 W/mK or less.

24. The heater assembly according to claim 15, wherein the heater assembly is configured such that when a nonzero voltage is applied across the heating element between the first and the second electrical contacts, temperatures of the plurality of heating portions increase more than temperatures of the at least one attachment portions.

25. The heater assembly according to claim 15, wherein the heating element is serpentine in shape.

26. An aerosol-generating device, comprising:
a heater assembly comprising:
a heating element,
a first electrical contact in electrical contact with a first end of the heating element,
a second electrical contact in electrical contact with a second end of the heating element, the heating element providing a continuous electrical path between the first electrical contact and the second electrical contact, and
a frame comprising an aperture in a first plane,
wherein the heating element comprises a plurality of heating portions and at least one attachment portion positioned between heating portions along the continuous electrical path,
wherein the heating element is fixed to the frame and wherein each heating portion is within or overlies the aperture and is separated from the frame by at least one attachment portion,
wherein a cross-sectional area of each heating portion perpendicular to a direction of the continuous electrical path is less than a cross-sectional area of each attachment portion perpendicular to the direction of the continuous electrical path,
wherein the heating element further comprises at least one heat-isolating portion, wherein each attachment portion is separated from the frame by one heat-isolating portion, and wherein the plurality of heating portions, the at least one attachment portions, and the at least one heat-isolating portion are all integrally formed;
an air flow passage defined between an air inlet and an air outlet, the airflow passage being in fluid communication with the heating element;
a power supply in electrical contact with the first and the second electrical contacts and being configured to supply power to the heating element; and
control circuitry configured to control a supply of power from the power supply to the heating element.

27. An aerosol-generating system, comprising:
a cartridge comprising;
an aerosol-forming substrate in fluid communication with a wicking material,
wherein the wicking material forms part of an external surface of the cartridge; and
an aerosol-generating device comprising:
a heater assembly comprising:
a heating element,
a first electrical contact in electrical contact with a first end of the heating element, and
a second electrical contact in electrical contact with a second end of the heating element, the heating element providing a continuous electrical path between the first electrical contact and the second electrical contact,
a frame comprising an aperture in a first plane,
wherein the heating element comprises a plurality of heating portions and at least one attachment portion positioned between heating portions along the continuous electrical path,
wherein the heating element is fixed to the frame and wherein each heating portion is within or overlies the aperture and is separated from the frame by at least one attachment portion,
wherein the cross-sectional area of each heating portion perpendicular to the direction of the continuous electrical path is less than the cross-sectional area of each attachment portion perpendicular to the direction of the continuous electrical path, and
wherein the heating element further comprises at least one heat-isolating portion, wherein each attachment portion is separated from the frame by one heat-isolating portion, and wherein the plurality of heating portions, the at least one attachment portions, and the at least one heat-isolating portion are all integrally formed,
an air flow passage defined between an air inlet and an air outlet, the airflow passage being in fluid communication with the heating element,
a power supply in electrical contact with the first and the second electrical contacts and being configured to supply power to the heating element, and
control circuitry configured to control a supply of power from the power supply to the heating element,
wherein the cartridge is reversibly couplable to the aerosol-generating device, such that when the cartridge is coupled to the aerosol-generating device the wicking material is in direct contact with the heating element.

28. A cartridge for an aerosol-generating system, the cartridge comprising:
an aerosol-forming substrate in fluid communication with a wicking material; and
a heater assembly comprising:
a heating element, wherein the wicking material is in contact with the heating element,
a first electrical contact in electrical contact with a first end of the heating element,
a second electrical contact in electrical contact with a second end of the heating element, the heating element providing a continuous electrical path between the first electrical contact and the second electrical contact, and
a frame comprising an aperture,
wherein the heating element comprises a plurality of heating portions and at least one attachment portion positioned between heating portions along the continuous electrical path,
wherein the heating element is fixed to the frame and wherein each heating portion is within or overlies the aperture and is separated from the frame by at least one attachment portion, and
wherein the cross-sectional area of each heating portion perpendicular to a direction of the continuous electrical path is less than a cross-sectional area of each attachment portion perpendicular to the direction of the continuous electrical path,
wherein the heating element further comprises at least one heat-isolating portion,
wherein each attachment portion is separated from the frame by one heat-isolating portion, and
wherein the plurality of heating portions, the at least one attachment portions, and the at least one heat-isolating portion are all integrally formed.
